(19) United States
(12) Patent Application Publication
(10) Pub. No.: US 2015/0287227 A1
(43) Pub. Date: Oct. 8, 2015

(54) DYNAMIC FILLING OF SHAPES FOR GRAPHICAL DISPLAY OF DATA

(71) Applicant: InsightSoftware.com International Unlimited, Bray (IE)

(72) Inventor: Jonathan Reeves, Centennial, CO (US)

(21) Appl. No.: 14/680,032

(22) Filed: Apr. 6, 2015

Related U.S. Application Data
(60) Provisional application No. 61/975,880, filed on Apr. 6, 2014.

(51) Int. Cl. G06T 11/40; G06T 11/20

(52) U.S. Cl. CPC G06T 11/40; G06T 11/206; G06T 2200/28; G06T 2210/36

(57) ABSTRACT

This disclosure describes systems, methods, and apparatus for visualizing data. In particular, the present disclosure creates infographics for any complex shape. Thus, a user can provide a logo, symbol, photograph, drawing, etc. and this disclosure provides a way to turn the provided image into an infographic—or chart, where a shape or outline of the image is filled proportionally to data. Importantly, the fill level can vary with changing data and is thus not limited to data points known at a time when the infographic is created. Further, while simple shapes such as circles, donuts, and rectangles are fillable with dynamic data using existing scripts, there are so many additional and more complex shapes in existence that scripts cannot be written to account for all of these shapes. The present disclosure enables dynamic filling of shapes that cannot be filled using existing scripts.

### CLAIM OF PRIORITY UNDER 35 U.S.C. §119

The present Application for Patent claims priority to Provisional Application No. 61/975,880 entitled “DYNAMIC FILLING OF SHAPES FOR GRAPHICAL DISPLAY OF DATA” filed Apr. 6, 2014, and assigned to the assignee hereof and hereby expressly incorporated by reference herein.

### FIELD OF THE DISCLOSURE

The present disclosure relates generally to data visualization. In particular, but not by way of limitation, the present disclosure relates to systems, methods and apparatuses for graphing data within silhouettes of relevant images.

### BACKGROUND

Infographics, or the display of data using proportional numbers of symbols and/or partially filled silhouettes have long been practiced. However, these graphics tend to be static displays that are rendered from a single image and are thus neither dynamic nor easily modified. For instance, where a graphic is to show an amount of water being used, a graphic artist may draw the outlines of ten water bottles, and fill eight of them with a blue color and two with a red color. This image can then be stored and rendered when needed. If a dynamic visualization is needed, for instance, to show different data values, then the artist must draft two or more images, each having a different number of blue and red water bottles. If at some later point there is a desire to display different data, or use shapes other than water bottles, the artist would need to create additional images for each new data point and/or each new shape. This is not feasible where the infographic needs to display multiple data points that are unknown to the artist at the time of creation.

At the same time, there are software functions and methods capable of dynamically filling basic shapes with fill levels representing different data sets/values. For instance, HighCharts can create bar graphs, column charts, line graphs, area graphs, pie charts, bubble charts, donut charts, and gauges (i.e., partial donut charts), pyramid charts, and funnel charts (i.e., a finite number of simple shapes having few edges or vertices and easily-described by existing equations). Each of these chart types have their own pre-coded functions based on equations that describe these simple shapes. For instance, funnel charts are formed by calling the “funnel” function, while pyramid charts are formed by calling the “pyramid” function. Similarly, the scalable vector graphics (SVG) language allows the easy creation of simple/primitive shapes with known/obvious properties that can be used to resemble things like bar graphs (e.g., rectangles with width and height). More complex shapes are expressed through a custom vector path/outline and therefore don't have built-in nor obvious functions to control how they are drawn programmatically. Due to the brute force nature of this approach, complex vector images would require vast programming time and large processing resources to render, and therefore are not satisfactory for filling any complex shape. Additionally, where existing functions have been scripted to simplify the filling of certain shapes, only a limited number of such existing scripts have been created, and thus only a small fraction of the infinite number of possible shapes are covered by such existing scripts.

As seen, existing methods for displaying infographics either require the time-intensive drafting of different shapes and data values by a skilled artist, where every data value and every shape requires a separate drawing, or require an existing script, thus limiting software-generated infographics to those shapes that have been pre-scripted by a programmer.

There is thus a need in the art for systems and methods that can autonomously create and render infographics for any shape using dynamic data sets.

### SUMMARY OF THE DISCLOSURE

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Some embodiments of the disclosure may be characterized as a system for visualizing data. The system can include a memory and a shape-charting engine. The memory can store a data set. The shape-charting engine can include a shape retrieval module, a first vector image, a data retrieval module, a fill level calculation module, and a second vector image creation module. The shape retrieval module can be configured to retrieve a shape. The first vector image creation module can be configured to convert the shape to a first vector image. The data retrieval module can be configured to obtain a data set. The fill level calculation module can be configured to calculate a height of a fill level as a percentage of a height of the first vector image, where the percentage corresponds to one or more data points in the data set. The second vector image creation module can be configured to generate a second vector image comprising the fill level bounded by the first vector image so that the fill level appears to partially or fully fill the first vector image when the second vector image is created. Further, the second vector image can be generated from the first vector image and the fill level

Other embodiments of the disclosure may also be characterized as a system for visualizing data. The system can include a shape retrieval module, a data retrieval module, and a fill level calculation module. The shape retrieval module can be configured to retrieve a first vector image and the data retrieval module can be configured to obtain a data set. The fill level calculation module can be configured to calculate a plurality of fill levels as percentages of a first dimension of the first vector image, where each of the percentages corresponds to a data point in the data set. The second vector image creation module can be configured to generate a second vector image with a changing fill, the fill based on a union between one of the fill levels and the first vector image

Other embodiments of the disclosure can be characterized as non-transitory, tangible computer readable storage medium, encoded with processor readable instructions to perform a method for visualizing data. The method can include retrieving a first vector image and obtaining a data set (in any order). The method can further include calculating a dimension of a first fill level based on the data set, the first fill level being rectangular and having at least one dimension that is equal to or greater than a dimension of the first vector image. The method can further include generating a second vector image comprising the first fill level bounded by the first vector image so that the first fill level appears to partially or fully fill the first vector image, wherein the second vector image is generated from the first vector image and the fill level. The second vector image can be generated on the fly rather than by being selected from a plurality of previously-generated images each showing one of a finite number of different fill levels for the first vector image.

### BRIEF DESCRIPTION OF THE DRAWINGS

Various objects and advantages and a more complete understanding of the present invention are apparent and more readily appreciated by referring to the following detailed description and to the appended claims when taken in conjunction with the accompanying drawings:

FIG. 1A illustrates a graphic shape dynamically filled via a first data set in order to graphically display dynamic data;

FIG. 1B illustrates a graphic shape dynamically filled via two different data sets in order to graphically display dynamic data;

FIG. 2 shows additional aspects of FIG. 1B;

FIG. 3 shows a shape having a bounding box;

FIG. 4 shows how the same bounding box can be used to measure a width of the shape when the fill level is expressed in the horizontal dimension;

FIG. 5 shows a shape displayed with a fill level that uses an angled dimension as the representative scale;

FIG. 6 shows a shape having three different data points plotted therein;

FIG. 7 shows a shape having three different data points plotted therein at different times;

FIG. 8 shows a shape having a fill level along with composited shapes and labels;

FIG. 9 shows a shape having a fill level comprising symbols or icons;

FIG. 10 shows the shape of FIG. 9 having a fill level comprising symbols or icons, some of which are partially filled;

FIG. 11 shows a shape having a fill level comprising two different data points, one graphed by a solid fill level and one graphed via icons;

FIG. 12 shows a shape having a variety of features than enhance data visualization;

FIG. 13 shows a shape having a fill level that is graphed in a two-dimensional scale;

FIG. 14 shows a shape with two different fill levels, representing two different data points, or a dynamic data point at two different times;

FIG. 15 shows a shape with a single fill level that expands and contracts according to two discrete vectors;

FIG. 16 shows a method of dynamically filling shapes for the graphical display of data;

FIG. 17 shows sub-operations of the method illustrated in FIG. 16;

FIG. 18 shows further sub-operations of the method illustrated in FIG. 16;

FIG. 19 shows further sub-operation of the method illustrated in FIG. 16;

FIG. 20 shows further sub-operation of the method illustrated in FIG. 16;

FIG. 21 shows a diagrammatic representation of one embodiment of a computer system within which a set of instructions can execute;

FIG. 22A shows a first vector image overlapping with a fill level;

FIG. 22B shows a second vector image;

FIG. 23 shows a system for visualizing data according to one embodiment of this disclosure;

FIG. 24A shows rectangles overlapping two different shapes where the rectangles have the same area but different dimensions;

FIG. 24B shows rectangles overlapping two different shapes where the rectangles have different area and only one differing dimension;

FIG. 25 shows a method of visualizing data according to one embodiment of this disclosure; and

FIG. 26 shows three different aspects of an infographic according to embodiments of this disclosure.

### DETAILED DESCRIPTION

As noted in the Background, existing methods of creating infographics are either limited to simple shapes, such as the rectangles, circles, donuts, and pyramids that programmers have created via brute force scripting methods (e.g., using an equation to describe and fill a shape), or to complex shapes created by an artist that can only display previously-known data (i.e., at the time that an artist created the complex shapes). Yet, if one wants to fill a complex shape, such as a company logo, outline of a product, or geographic boundaries of sales regions with dynamic data that is ever changing, neither of the above solutions is viable. As a more specific example, take a company sales representative who wishes to show sales levels for different regions of the United States using an infographic of the United States. Traditional methods would require that an artist create images of the United States and the different sales regions, each using a different color, and a different image created for every set of data points that the sales representative wishes to show. Moreover, for each presentation the data will likely have changed, and thus the artist will have to recreate the infographic every time that the sales representative wishes to show the infographic. In the case of the sales rep having multiple meetings in a given day where sales values are changing throughout the day, this task becomes nearly impossible to coordinate with the infographic-creating-artist. The other traditional alternative is to rely on a scripted function that can dynamically fill the United States sales regions in real time. However, this requires that the company expend resources to create a script that can only render an infographic of sales in the United States and only for the regions specified. If those regions change, if new regions are added, if the sales force suddenly expands to Canada or China, then the programmer will have to modify the script (at the cost of great time and resources). This is not only a burden on the company, especially smaller ones with limited budgets, but in the case of such changes happening rapidly, there may not be enough time for the programmer to create a new script. For instance, the sales rep may be flying to a meeting and be inspired to change the infographic from a map of the United States to shapes of the product being sold. Even if a call to the programmer could be made in midair, the changes to the code could not be made fast enough for the sales rep to use the new infographics in his/her presentation upon landing. Further, as the complexity of the shape increases, the programming burden on the software designer becomes increasingly difficult if not impossible given finite time and monetary resources.

Thus, there is a need for infographics that can be filled using data that changes in real-time, where the shapes being filled can be selected from any of an infinite number of shapes and changed/selected without user-perceived delay. In other words, there is a need to form dynamic infographics from any shape provided. It should also be noted that the existence of infographics goes back over a two centuries (and arguably more) without anyone conceiving of a viable solution to this problem (e.g., see The Commercial and Political Atlas, William Playfair, 1786; see also The Coxcomb Chart, Florence Nightingale, 1857; see also Visual Display, Edward Tufte, 1975).

The word “exemplary” is used herein to mean “serving as an example, instance, or illustration.” Any embodiment described herein as “exemplary” is not necessarily to be construed as preferred or advantageous over other embodiments.

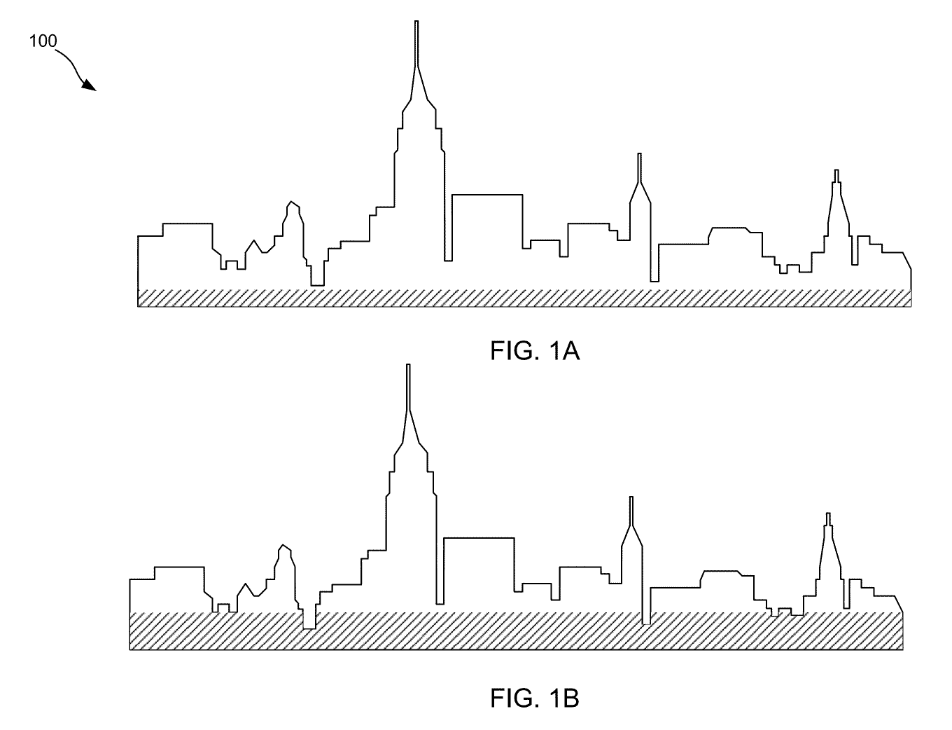

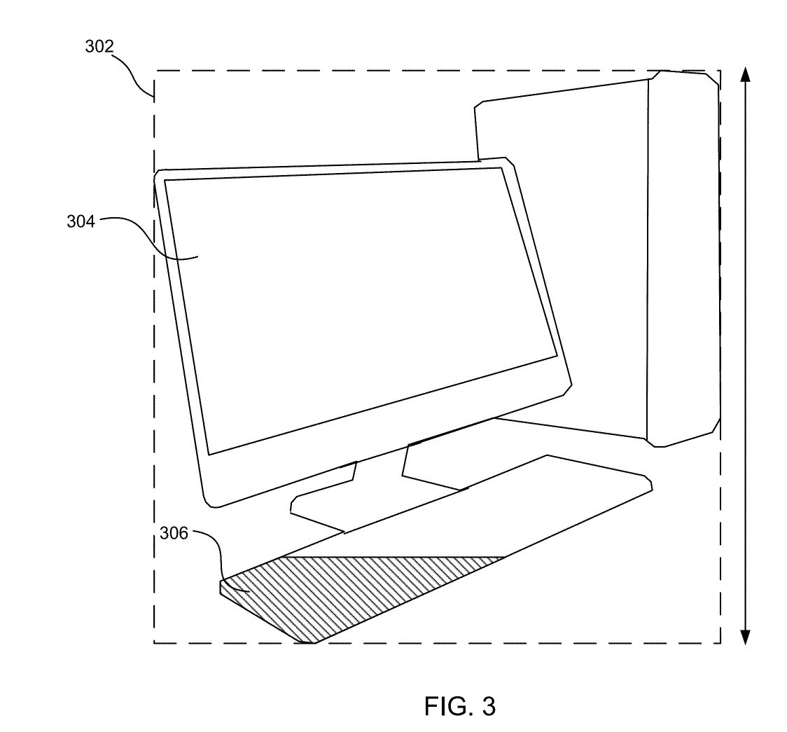

For the purposes of this disclosure a “shape” means a two-dimensional area defined by an outline that may or may not include one or more lines or shapes within the outline in addition to a fill level (e.g., compare FIG. 1A and FIG. 3).

For the purposes of this disclosure, a first or simple shape (or shapes) is rendered and filled based on existing or predefined functions (other related terms include scripts, objects, procedures, routines, lines of code, etc.). By this it is meant, that software functions currently exist in various coding languages (e.g., HTML, JAVA, C++, PYTHON, etc) that enable the graphing of data within simple pre-defined shapes. For instance, such simple shapes as bars, pies, and donuts are typically rendered via existing or predefined functions. These functions may use equations to describe and fill a shape.

As noted above, there is a need for systems, methods, and apparatus that can turn the infinite number of imaginable shapes, especially complex or second shapes into a shape that can be filled proportionally to one or more data values (also known as an infographic). Complex shapes are therefore those shapes that do not have predefined functions that allow those shapes to be filled (i.e., turned into an infographic). This disclosure does not seek to protect the creation of specific complex shapes, but rather systems, methods, and apparatus having the ability to dynamically fill any shape (contrast this with existing methods that are only capable of filling a limited set of shapes—those for which existing scripts have been written).

For the purposes of this disclosure a shape-charting engine comprises circuits and/or modules configured to generate graphs or infographics from a shape or complex shape.

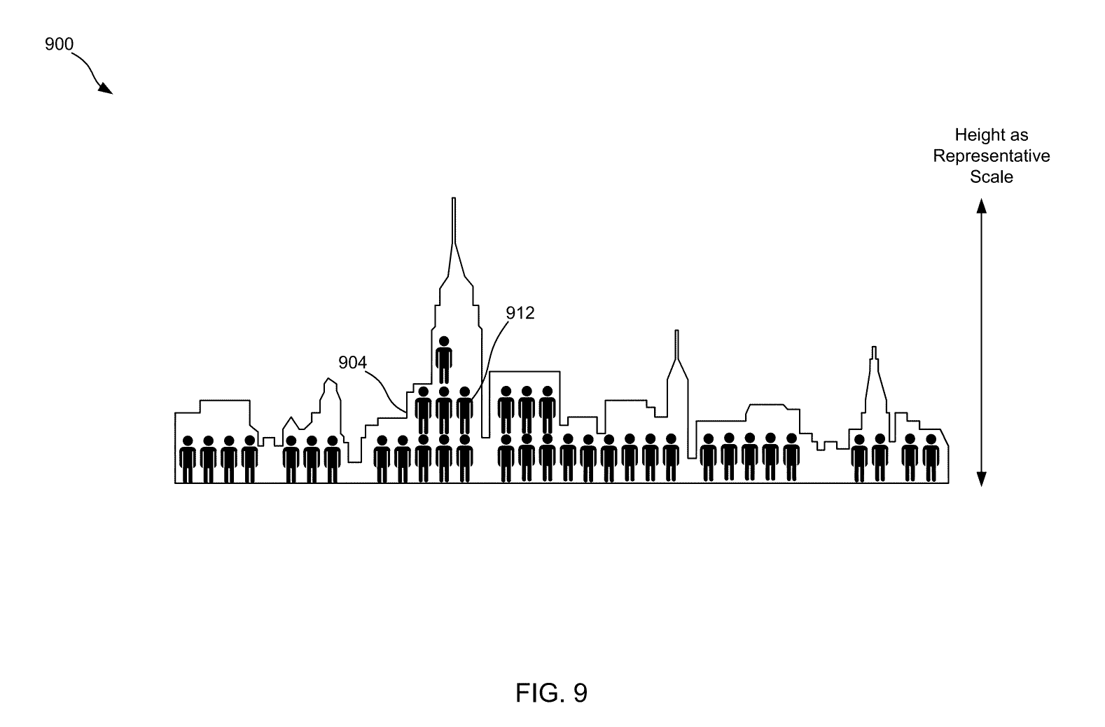

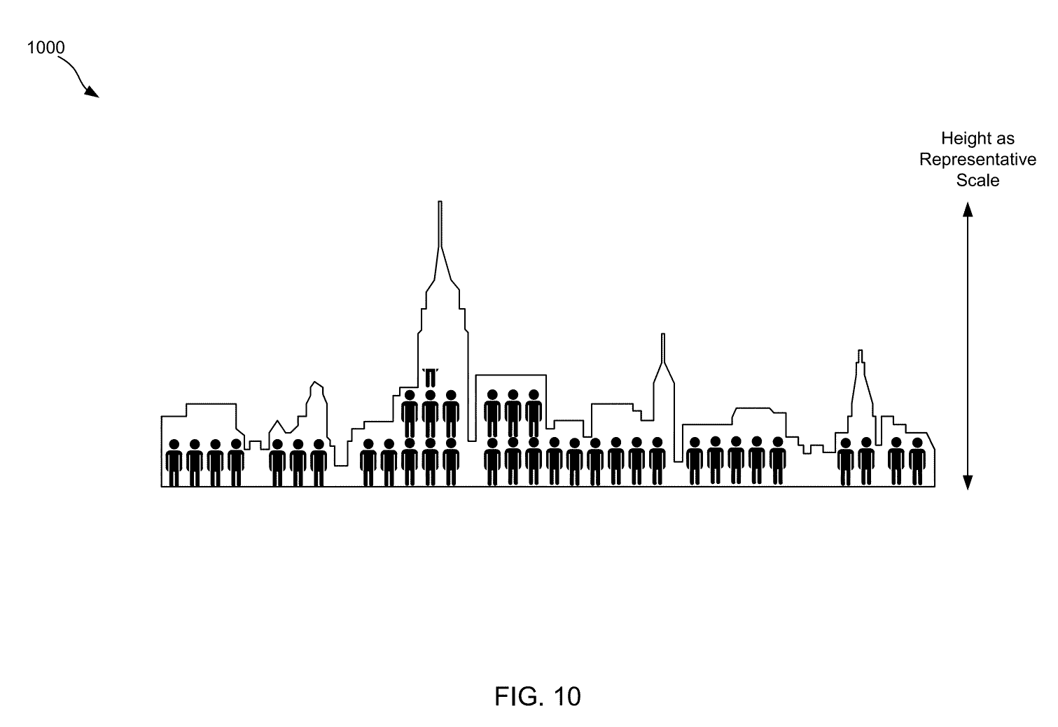

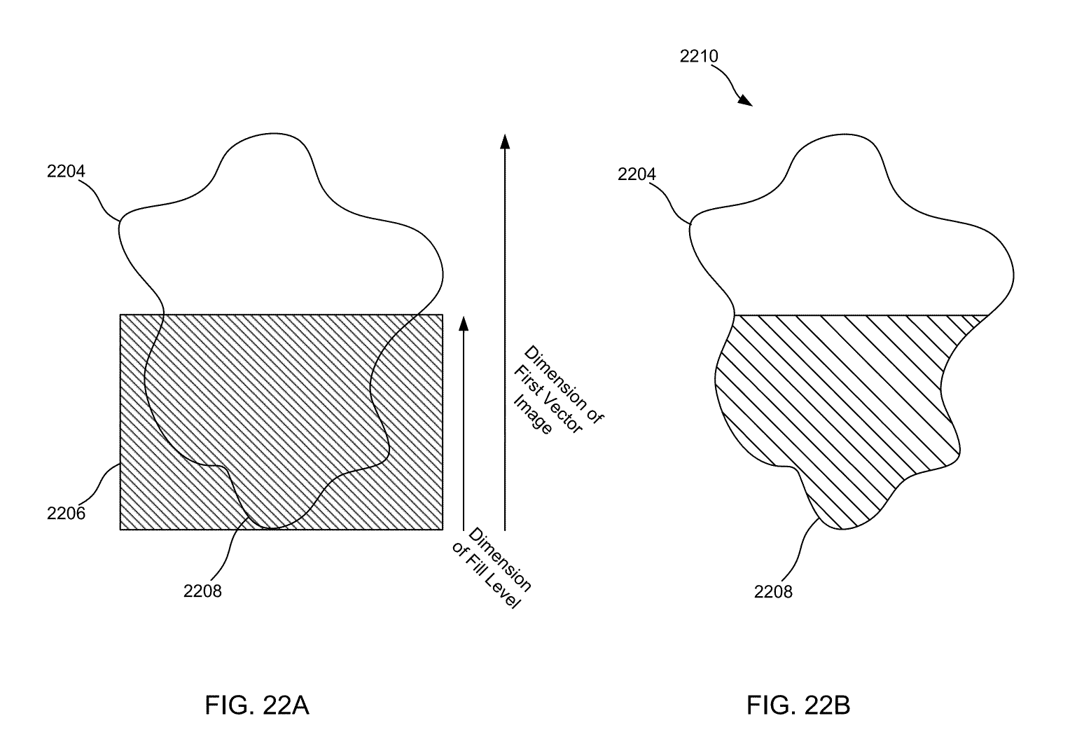

For the purposes of this disclosure a “fill” means a two-dimensional region of a shape that is filled with a color, texture (e.g., 2208 in FIG. 22), or pattern (e.g., repeating icons, images or other shapes as in FIGS. 9 and 10), any of which can optionally include some level of transparency.

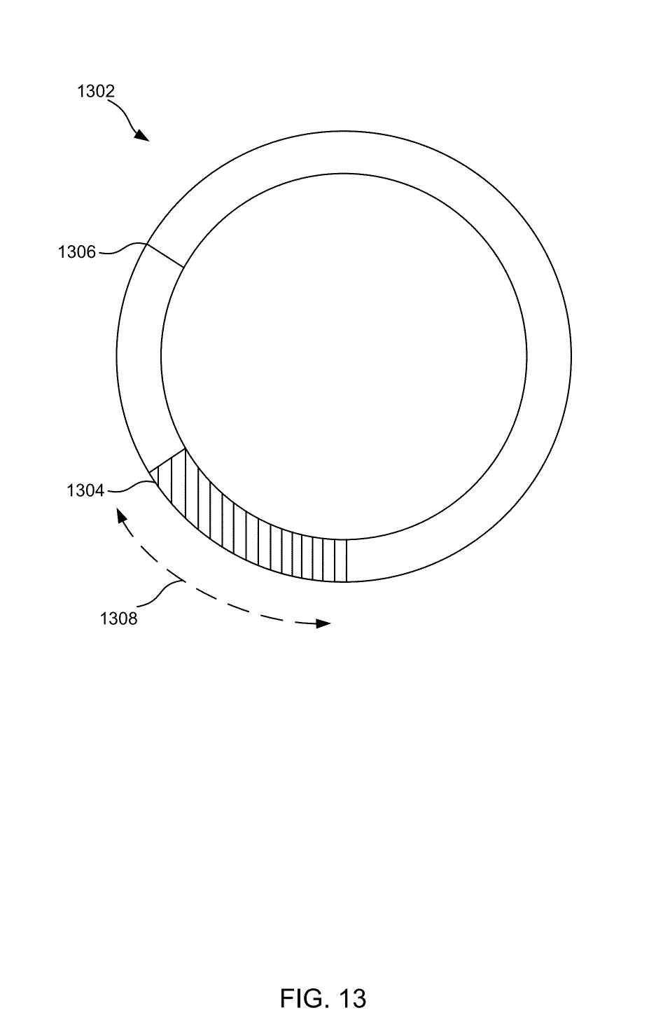

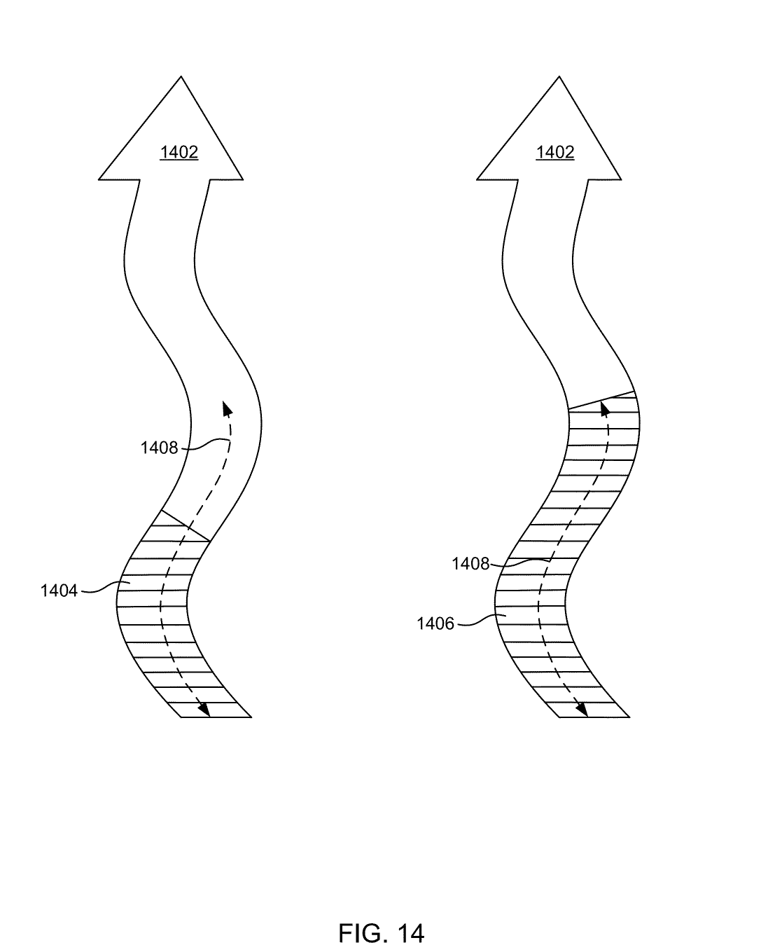

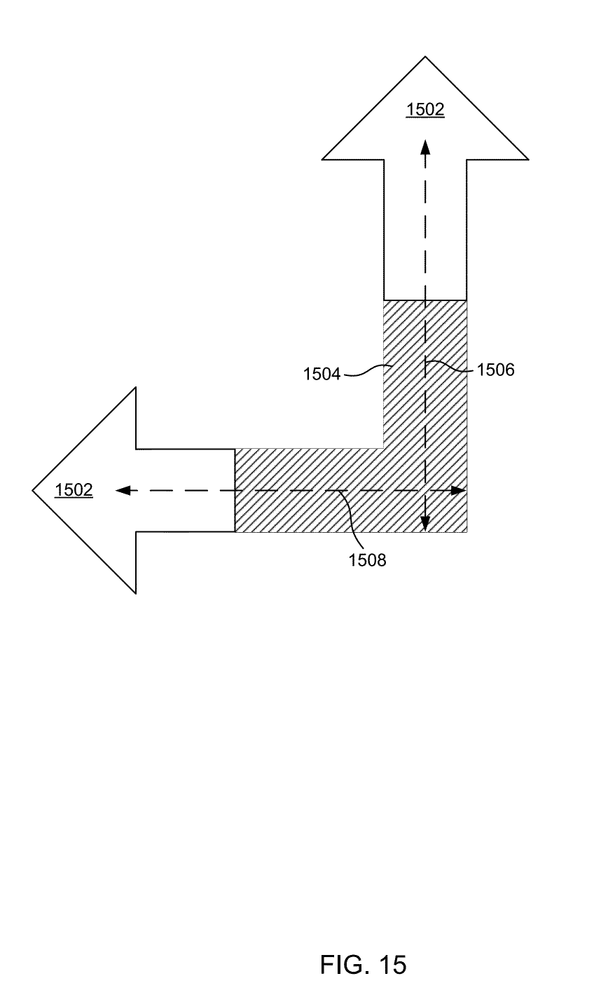

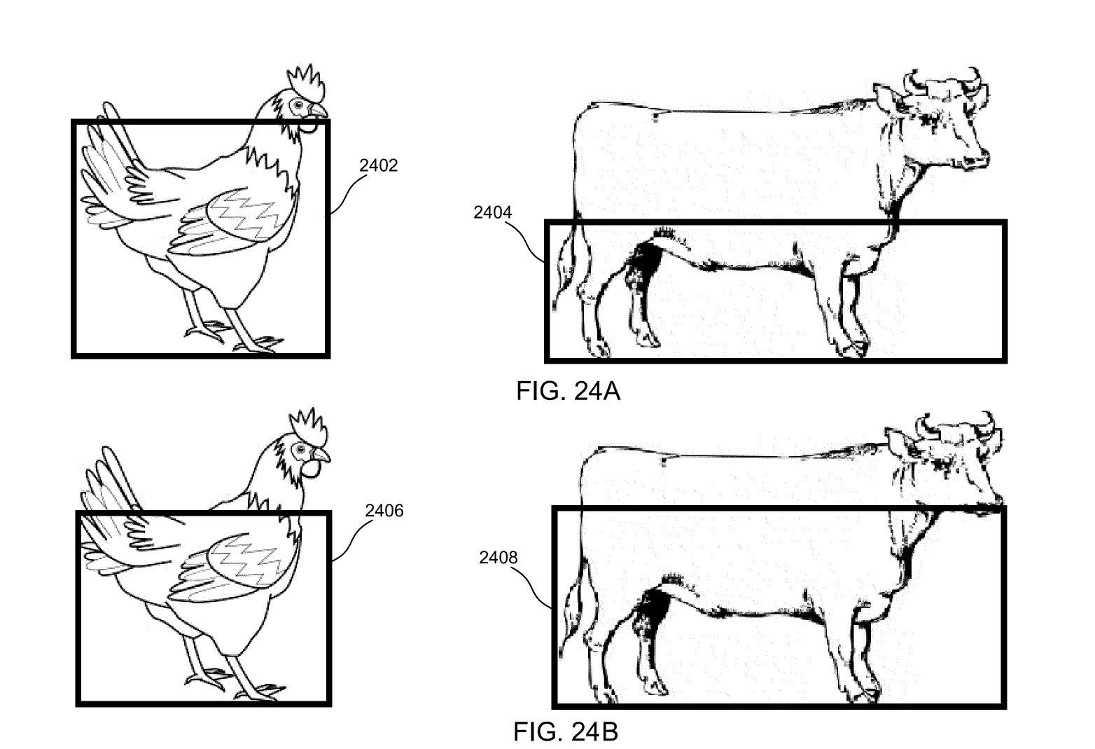

A fill level, in an embodiment, is a rectangle having a dimension, such as height or elevation, that corresponds to a data value (e.g., 2206 in FIGS. 22, and 2406 and 2408 in FIG. 24). Multiple data values can correspond to multiple fill levels. For instance, a ratio or percentage of a dimension (e.g., height) of a fill level relative to a dimension (e.g., height) of a first shape can be based on a data value. Fill levels can often move along the dimension as a function of changing data values or as a function of plotting different data values within a given data set (e.g., see FIGS. 1A and 1B). However, in other instances, a fill level can extend along a spline (e.g., FIGS. 13 and 14) or along two dimensions (e.g., FIG. 15). Where a three-dimensional display is used, “shape” can also include a three-dimensional volume defined by an outline surface that may or may not include one or more lines, planes, surfaces, or objects within the outline surface in addition to a one-dimensional, two-dimensional, or three-dimensional fill level (e.g., a fill volume or a fill surface). For the purposes of this disclosure a “fill volume” is a volume within a three-dimensional shape having a different color, texture, pattern, and/or transparency than a remaining volume within the three-dimensional shape. For the purposes of this disclosure a “fill surface” is a surface within a three-dimensional shape having a different color, texture, pattern, and/or transparency than a remaining volume within the three-dimensional shape.

For the purposes of this disclosure a vector image (or vector graphic) is based on a definition of geometric shapes. Shapes are defined by precise mathematically defined Cartesian points. Thus, the shapes may be lines, rectangles, curves, or any arbitrary polygon defined by mathematical points. The collection of one or more these geometric shapes and their mathematical definitions form a vector image. Vector images can be magnified infinitely without loss of quality, while pixel-based (or raster) images cannot (e.g., images rendered by HTML's Canvas functionality).

Shapes in a vector image are divided up into strokes and fills. Strokes indicate that a vector shape should be drawn with a constant width of pixels of some color value. Fills indicate that the boundary of a shape should be closed and the interior filled with pixels of some color value. Strokes and fills that share the same shape differ in the method by which a shape is rendered.

The present invention overcomes the limitations and shortcomings of the prior art and provides dynamic infographics formed from any shape. The system and apparatus of the present disclosure includes one or more processors connected to one or more display devices, one or more input devices, one or more memory components, and one or more storage devices. The one or more storage devices can contain an operating system, and display routines, while the memory components can contain a shape-charting engine, a first vector image, a second vector image, a fill level, a fill, and a data set, to name a few.

Charts are historically directed toward accuracy at all costs, and most of the time utilize shapes our brains can understand quickly, circles and rectangles, all of which are vastly simpler for us to gauge a rough portion of as a percentage. More complex shapes (e.g., outlines from photographs, clipart, company logos, drawings, etc) that this disclosure is directed to filling, offer an extra layer of information intrinsically in that they are not a rectangle but an illustrative shape in their own right. This step towards infographics (as opposed to charts) is about being able to represent data as better consumable ‘information’, at a glance. It's about distilling the raw data down and abstracting it away into a visualization that gives a viewer the information (and extra layers of information) needed without the need to read legends and lookup labels. The idea of a red COKE can shape next to a blue PEPSI can shape, with the COKE can filled nearly to the top and the PEPSI can somewhere in the middle, tells an instant story (without the need for text). Thus the visual impression of data is more important than an accuracy of the visualization.

When endeavoring to fill a 2D shape, such as the shape 204, based on a data value, the assumption would be that using the ‘area’ of the shape to distribute a fill, such as fill 206, proportionally would be the most accurate and representative way to illustrate the measure. While this is the most accurate way to fill a shape, it is not always visually the most representative or visually the most useful to a viewer. In common scenarios, one is often comparing two or more values, each value represented by a fill in a different shape (e.g., first data in a COKE can and second data in a PEPSI can, or first data in an outline of a chicken and second data in an outline of a cow). Filling by area can skew human interpretation of the underlying values.

For example, let us say that we want to show a number of phones sold in the United Kingdom compared to those sold in the United States. In both cases our numbers are 10,000 units. To represent this comparison we use shapes of the United Kingdom and the United States. In order to fill the shapes proportionally we must define what 0% and 100% of the area represents (our minimum and maximum). Because these shapes are being compared, it's important that they are on the same scale (value wise), so essentially we are saying their areas have to be the same, but they can't be. With the two shapes lined up side by side (as would be normal, so as to aid with visual comparison), one would expect the fill of the United States to be aligned with that of the United Kingdom. Yet, by using the area to determine the fill level, the bottom of the United States comprises Florida, which has a smaller width than the South of the United Kingdom, and therefore the United States will fill vertically much faster. Then, when the fill height reaches Texas, Arizona, Mississippi (i.e., the South of the United States), the width of the shape will be vastly greater than that of the United Kingdom and thus the United Kingdom will appear to fill much faster than the United States for these data values. So, as data values rise in this comparison, filling based on area may be accurate, but visually misleading for all but the most astute viewers. Since these types of charts are typically used to convey general data comparisons at a quick glance, most viewers will be confused if not mislead by methods that fill shapes based on area. This is an observation previously unnoted in the prior art.

The inventor unexpectedly determined that if a single axis is used to fill rather than area, then more meaningful visualizations of the data are achieved. In the above example this could mean filling the United States and the United Kingdom based on a height or elevation, although other dimensions could be used.

This methodology could be considered an optical illusion, but it ensures that the correct understanding is derived from the data being viewed on what are often irregular shapes (that human brains cannot easily subdivide). The fact that accuracy is sacrificed, is somewhat a technicality, as perceptively the visualizations tell the correct story.

As another example, FIG. 24A shows a first shape as a chicken and a second shape as a cow. Assume the number of chickens and cows consumed each year is to be compared, and assume that the data shows that equivalent numbers of chickens and cows are consumed. A viewer would therefore expect to see similar heights or elevations of the fill level within each shape. However, since the cow's shape is more elongated than the chicken's, equal fill areas for the two shapes will not have the same height, as shown by the rectangles in FIG. 24A. Thus, an accurate representation of the data based on the area of the shape that is filled is actually misleading for a viewer. Unexpectedly, the inventor discovered that relying on a fill height or elevation rather than an area of the shape that is filled, is a more visually representative and more useful method for displaying infographics. As such, preferred methods of displaying data actually eschew accurate representations of data and may prefer calculating a ratio of a height of the fill level to a height of the shape as compared to calculating a ratio of the fill area to the total area of the shape (see FIG. 24B). In FIG. 24B one can see that the areas of the rectangles, or the fill levels, are unequal, yet the heights of the rectangles are the same. When the union of these fill levels and the chicken and cow shapes are performed in order to create a final image (or second vector image), the visual implication is that the data values charted by each shape are the same.

FIG. 1A and 1B illustrates a graphic shape dynamically filled via two different data sets, or via different data points in a single data set, in order to graphically display data. FIG. 1A shows the graphical representation of a first data value while FIG. 1B shows the graphical representation of a second data value greater than the first data value. The departure from the prior art is that these two data points can be automatically displayed as a fill level within the shape (e.g., the New York skyline) without any need for pre-drawn filled shapes, and that the fill level is based on a single axis (e.g., height) rather than via the area of the city shape that is filled. Said another way, the data that can be displayed in this fashion using prior art systems and methods is limited to a number of images that an artist is willing or has time to create. The herein disclosed systems and methods have no such limitation since they enable automatic graphing of any data value within any shape and do so on the fly. This means that a user can define a shape (e.g., an outline of a COKE bottle, an outline of a specialized tool, an outline of a company's logo), provide this shape to the herein disclosed systems and methods, then provide one or more data points, and those data points can then be rendered as a fill within the provided shape.

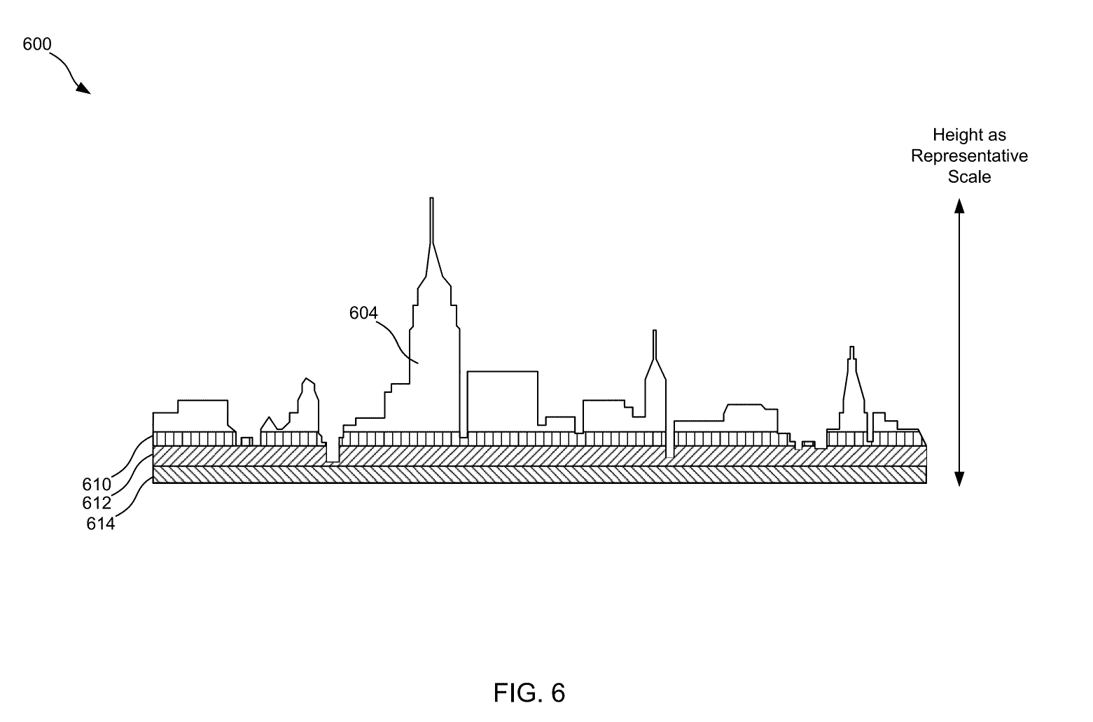

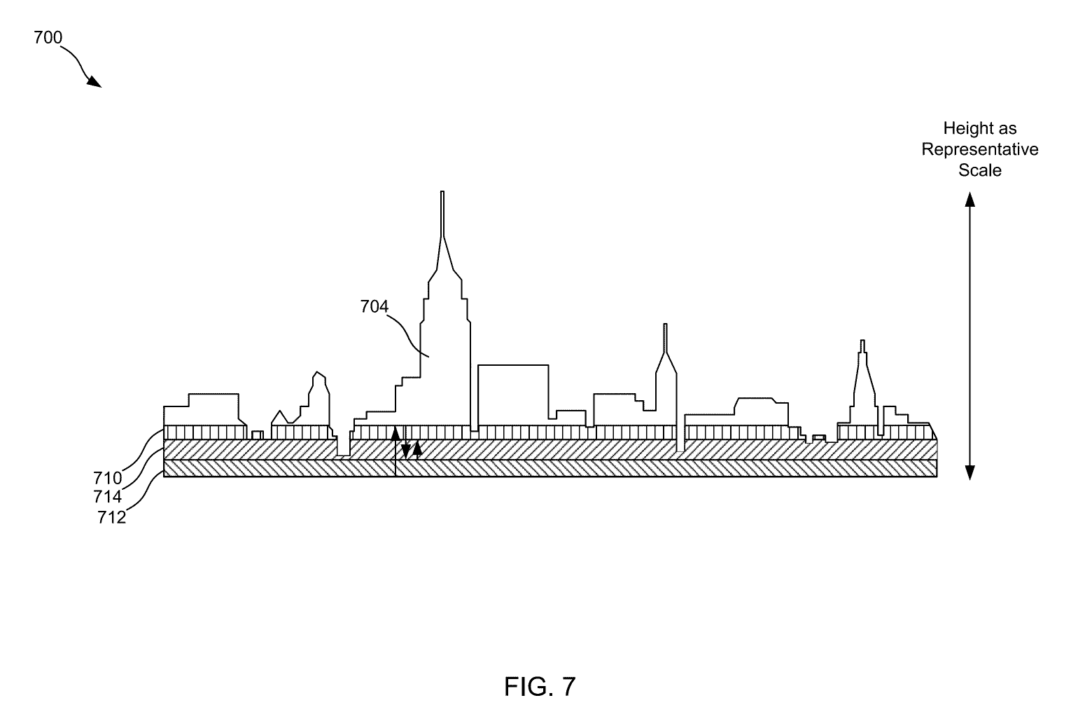

Further, multiple data points can be displayed as different levels within the provided shape at different times in an instance where dynamic displays are desired (e.g., FIG. 7). For instance, FIG. 1A can be rendered at a first time and represent a population level of New York City for a first year, and a moment later the fill level of FIG. 1B can be displayed representing a second population level for a second year. Additionally, different data points can be displayed as different levels within the provided shape at the same time (e.g., FIG. 6).

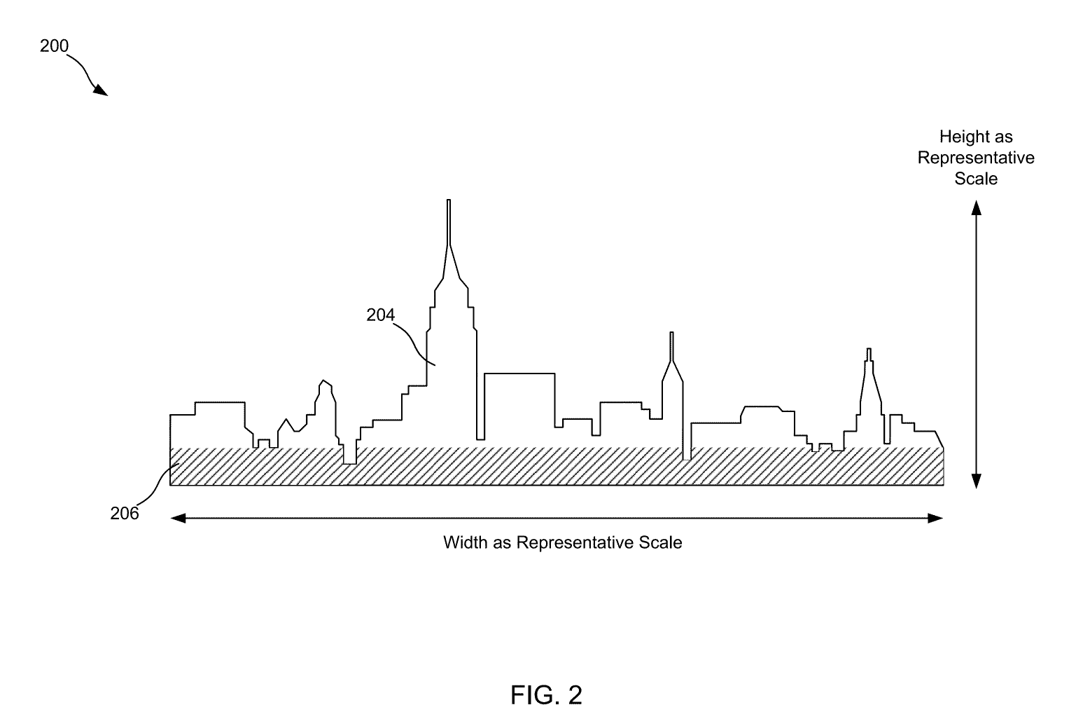

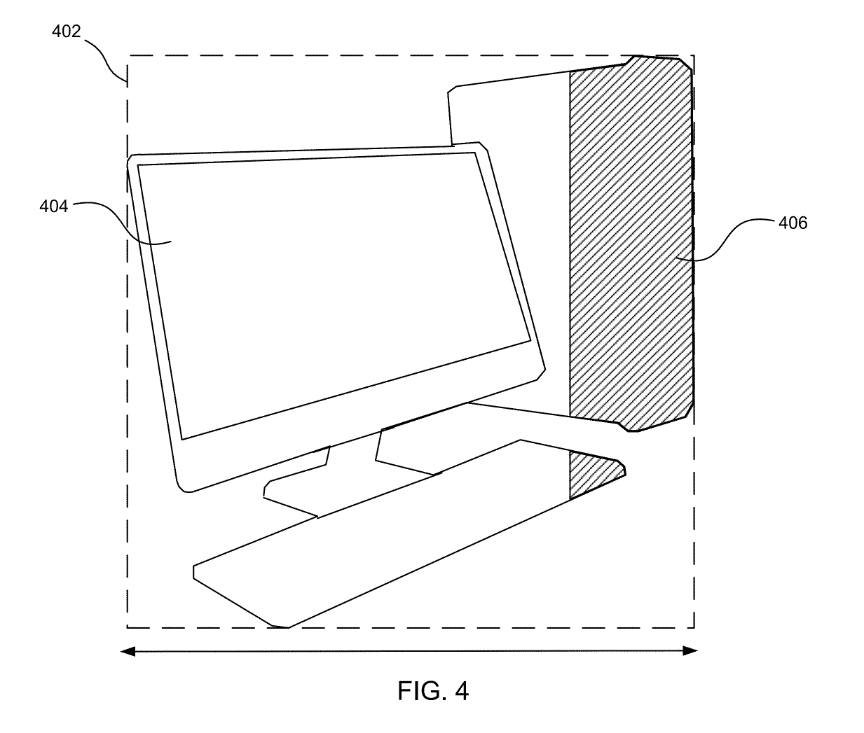

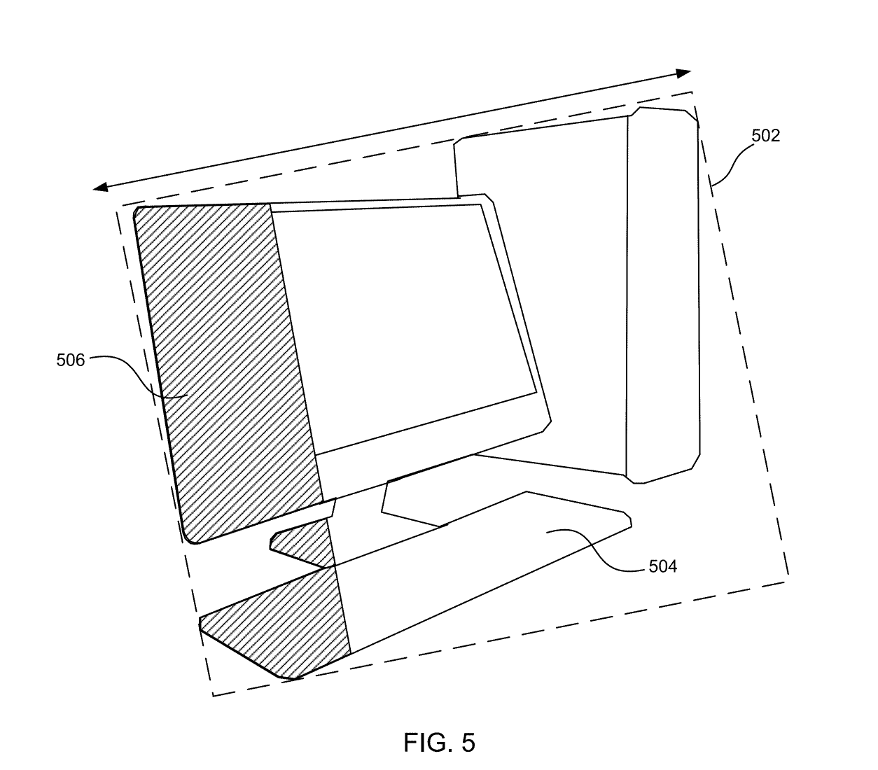

FIG. 2 shows various additional aspects of FIG. 1B. The shape 204 can again be displayed with a fill level 206 corresponding to a data point (or calculation relative to multiple data points, such as an average). The illustrated fill level 206 uses height or a vertical dimension as the representative scale, but in other embodiments, width or other dimensions can be used as the representative scale. For instance, FIG. 4 shows a shape 404 displayed with a fill level 406 that uses width or a lateral dimension as the representative scale. FIG. 5 shows a shape 504 displayed with a fill level 506 that uses an angled dimension as the representative scale. As seen, fill levels can be drawn relative to any scale and hence relative to any direction.

FIG. 3 shows a shape having a bounding box. The bounding box 302 surrounds the shape 304 and can be used to determine a reference level or reference area against which a data point is compared to in order to determine how to draw the fill 306. When a user provides a shape 304, a height of the shape 304 can be determined (e.g., in terms of pixels), or any other dimension. A system or method that fills the shape 304 can access or receive a data point as the basis for the fill 306, and determine a scale for displaying the fill 306, and a maximum value that the fill 306 can reach. This maximum value can correspond to the height of the bounding box 302. Looking at the scale and the data point, a vertical extent of the fill 306 can be calculated as a ratio (or percentage) of the data point over the maximum value. The vertical extent of the fill 306 is then used to render the fill 306. For instance, where the bounding box 302 has a height of 1000 pixels, and the data point is 20% of a maximum value, the fill 306 can have a height of 200 pixels from a bottom of the shape 304. In other embodiments, an area of the shape 304 can be calculated, and the extent of the fill 306 (e.g., a percentage of the shape's 304 area that is filled) can be made to match a ratio of the data point over a maximum value.

Where the fill expands and contracts in a horizontal plane, a width of the bounding box 302 can be used to determine a reference level or reference area against which the data point is compared to.

FIG. 4 shows how the same bounding box 402 can be used to measure a width of the shape 404 when the fill 406 is expressed in the horizontal dimension. Where the fill 406 is to be expressed relative to another dimension (e.g., at an angle), a bounding box 502 as seen in FIG. 5 can be generated so as to align with a desired dimension of the fill 506.

FIG. 6 shows a shape having three different data points plotted therein. The shape 604 includes three fills 610, 612, 614 in order of decreasing value, each corresponding to a different of the three data points. The fills 610, 612, 614 are plotted relative to height as the representative scale and hence the fill 610 representing a largest value is the tallest of the three fills 610, 612, 614. This is just one embodiment showing multiple data points graphed simultaneously within a single shape 604.

FIG. 7 shows a shape having three different data points plotted therein at different times. Alternatively, FIG. 7 can show how dynamic data might be displayed. Either way, at a first time, a first fill 710 is displayed. At a second time, a second fill 712 is displayed. At a third time, a third fill 714 is displayed. Such dynamic updating to the fill level can be the result of displaying three different data values from a given data set at different times (e.g., population levels for children, adults, and retired citizens), or as the result of displaying a single data point that is changing in time (e.g., a stock quote).

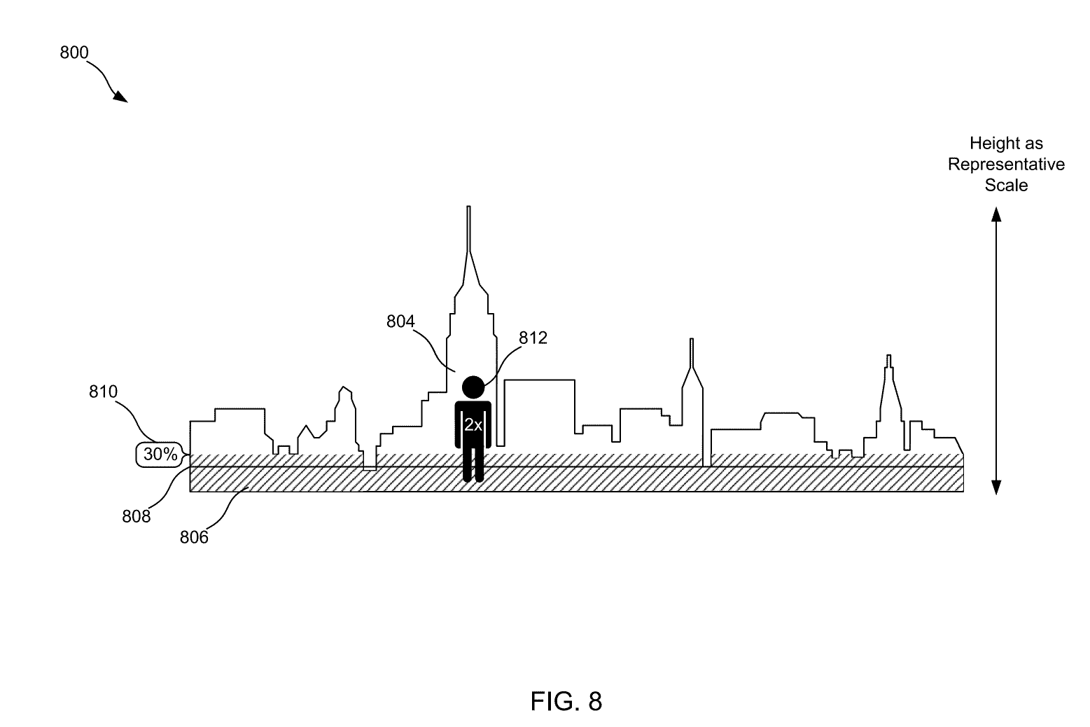

FIG. 8 shows a shape having a fill along with composited shapes and labels. The optional addition of a common scale of values to the visualization can provide an easy way to read off the levels as accurate values (if detail/accuracy is needed). The shape 804 includes a fill 806 as well as a threshold or goal line 808, a text indicator 810 of the value of the fill 806, and another symbolic indicator 812 that includes text. In particular, the symbolic indicator 812, here in the shape of a person, can be either solid (as shown), partially filled, or an outline. These different fill styles can be used to represent additional information via the symbolic indicator 812. For instance, when the fill 808 reaches the goal line 808, the symbolic indicator 812 may turn from an empty outline to a filled shape (as shown). Further, the text label within the symbolic indicator 812 can change color, font, become visible, or disappear, to name a few, when the fill 808 surpasses the goal line 808. The symbolic indicator 812 may also include a fill that corresponds to the data point used for the fill 806, or may include a fill that corresponds to a different data point or a different data set. Alternatively, the symbolic indicator 812 can be triggered by the fill falling below a threshold or by any other triggering event or calculation.

In some cases the fill can comprise shapes rather than a solid color or texture. FIG. 9 shows a shape having a fill comprising symbols or icons. In this embodiment, the shape 904 has a fill 912 that, rather than comprise a solid area of texture or color, here is filled using symbols or icons (e.g., humans). In some instances, a height (or other dimension), or number of rows, of the icons can solely represent a value. However, as shown, each icon represents a unit of measurement (e.g., one thousand persons or one million persons), such that a partial third row of icons is required in order to accurately represent the value being graphed. In other embodiments, additional refinement of the value being displayed can be achieved by only displaying partial icons, thus representing a portion of a unit of measurement (e.g., FIG. 10).

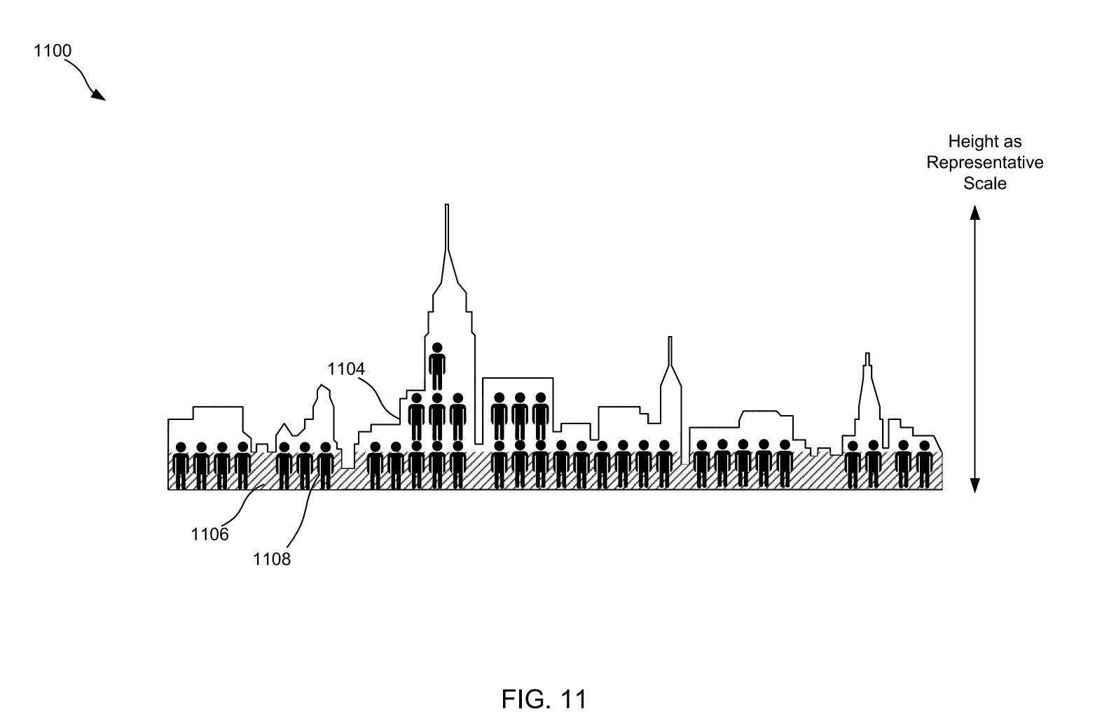

FIG. 11 shows a shape having a fill comprising two different data points, one graphed by a solid fill and one graphed via icons. The shape 1104 has a first fill 1106 representing a first data point, or first data set, via a solid fill, and a second fill 1108 representing a second data point, or second data set, via icons. Where multiple data points in a data set are to be graphed at different times, or where a data point varying in time is to be graphed, the first and second fills 1106, 1108 can change in time. One of skill in the art will recognize that more than three different data points or data sets can also be plotted in this fashion and any one or more of the fill can be displayed via icons or a solid fill. In some instances, a data point or data set can be graphed using both a solid fill and icons in order to provide greater visual punch to a data visualization. In such an embodiment, the fill will likely provide a more accurate representation of the data point to be graphed, while the icons can be more for illustrative purposes since they possess greater granularity than the solid fill.

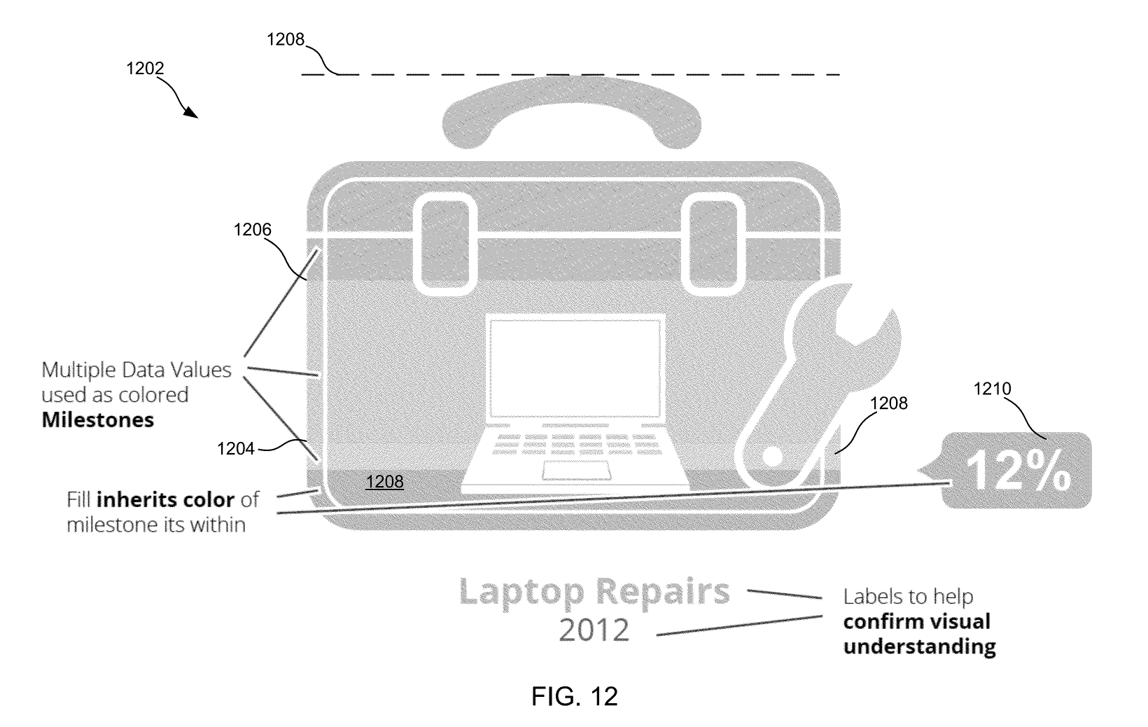

FIG. 12 shows a shape 1202 having a variety of features than enhance data visualization. The shape 1202 includes three different milestone 1204, 1206, 1208 (or goals, thresholds, etc.). The fill 1208 is below the first milestone 1204. Each milestone 1204, 1206, 1208 can include a region below the milestone 1204, 1206, 1208 and a lower milestone, or between the lowest milestone and the bottom of the shape 1202, that is colored or textured to help distinguish the regions below each milestone 1204, 1206, 1208. The fill 1208 can take on a color or texture of the region below a next milestone. For instance, here the first milestone 1204 has a light green region below it, and so the fill 1208 has a green shade as well. The next highest region has a pastel peach color, so when the fill 1208 surpasses the first milestone 1204, the fill level 1208 color can change to a shade of peach or orange. Similarly, upon surmounting the second milestone 1206, the fill 1208 can take on a red tone since the uppermost region has a pastel red color.

This graphic can also include a label 1210 that displays a number corresponding to the data value upon which the fill 1208 is calculated from. The label 1210 can also take on a color of the region that the fill 1208 is in, and thus here has taken on a green color until the fill 1208 passes the first milestone 1204.

FIG. 13 shows a shape 1302 having a fill 1304 that is graphed in a two-dimensional scale along a spline. In particular, the fill 1304 expands and contracts in a circular fashion thus appearing to follow a contour of the shape 1302. The direction of the arrow shows a changing vector marking a direction of expansion of the fill 1304 as the underlying data value changes. Like the shapes discussed previously, the shape 1302 can include one or more milestones 1306, and reaching the milestone 1306 can trigger events or changes to formatting of the shape 1302 or fill 1304.

This donut shape 1302 and the illustrated fill 1304 illustrate only one of many embodiments where the fill 1304 can expand and contract relative to a changing vector 1308. For instance, in other embodiments, the fill can expand and contract according to a vector that follows a contour of the shape (e.g., see FIG. 14). In other instances, the fill can expand radially thus following multiple vectors when expanding and contracting. In other instances, the fill can expand and contract according to multiple discrete vectors such as illustrated in FIG. 15.

FIG. 14 shows a shape 1402 with two different fills 1404, 1406, representing two different data points, or a dynamic data point at two different times. The fill 1404, 1406 can be seen to ‘snake’ its way up the shape 1402 such that expansion and contraction of the fill 1404, 1406 occurs according to a vector 1408 that changes at different heights to account for a contour of the shape 1402.

FIG. 15 shows a shape 1502 with a single fill 1504 that expands and contracts according to two discrete vectors 1506, 1508.

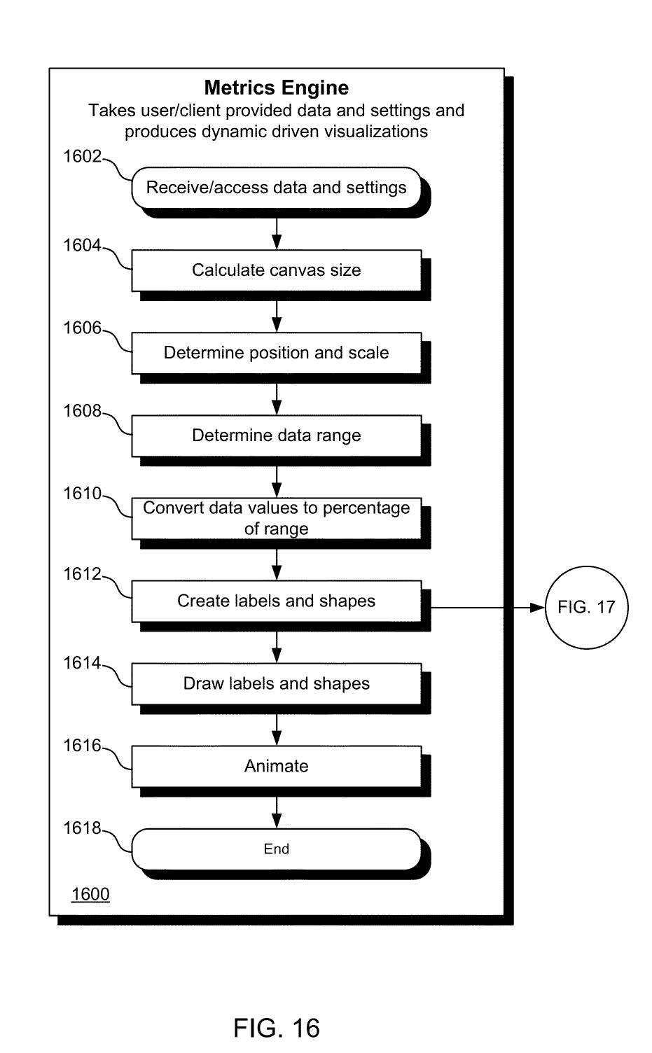

FIG. 16 shows a method of dynamically filling shapes for the graphical display of data. The method 1600 can be carried out by a metrics engine that takes user/client provided data and setting sand produces dynamic driven visualizations. The method 1600 begins by receiving or accessing data and settings (Block 1602). The data is then used to calculate a canvas size (Block 1604) and to determine a position and scale of the visualization (Block 1606). A range of the values can then be identified (or a maximum value can be provided in a setting) (Block 1608) and based on this range, the data values can be converted to a percentage of the range (Block 1610). Labels and shapes can then be created (Block 1612) and the labels and shapes can be drawn to a display (Block 1614) and optionally animated (Block 1616). The method 1600 can then end or repeat for a new set of data and settings. Also, where multiple data values or dynamic data are being visualized, the metrics engine 1600 can loop back to any of the operations illustrated. For instance, after labels and shapes are drawn for a first data value, the metrics engine 1600 can loop back and draw a new fill for the previously drawn shape (Block 1614).

Data and/or settings can be received from a user via a user interface (e.g., a web portal), digital communication (e.g., e-mail), or other means. Alternatively, the data and/or settings can reside in a memory and the metrics engine 1600 can access the data and/or settings in the memory. The data can comprise one or more data points and these can occur in a one, two, three, or four-dimensional array. The data may also be dynamic, meaning that it changes over time. In some embodiments, receiving data can be an ongoing or periodic operation.

The canvas size can be determined by creating a bounding box (see FIGS. 3-5) and then creating a canvas that at least encompasses the bounding box. Each canvas can contain one shape or multiple shapes. If multiple shapes are to be displayed on a canvas, then the canvas must encompass all the bounding boxes.

The position and scale of the infographic can be dictated by the settings. For instance, a user may specify that a certain infographic is to include four shapes each positioned in four corners of a canvas. Similarly, a user may have an idea as to the magnitude of the data and may therefore enter a scale for the data in the settings. The metrics engine 1600 can then use this user-provided scale to set a scale for the infographic.

The metrics engine 1600 can analyze the data and determine a range of values (Block 1608). The range of values can be determined for all data in a set or can be determined for some subset of the data. For instance, the range may be determined after removing or ignoring outlier data points. Or the data range may be determined from data points that were created within a period of time, such as the most recent five days of data points.

Given this range, the metrics engine 1600 can convert the data in the range to a percentage of the range, thus enabling the data to be displayed as a fill (Block 1610). In an alternative embodiment, an area of the shape can be determined (after the shape is created in Block 1612) and the fill can be determined to be a percentage of the data value over the area of the shape.

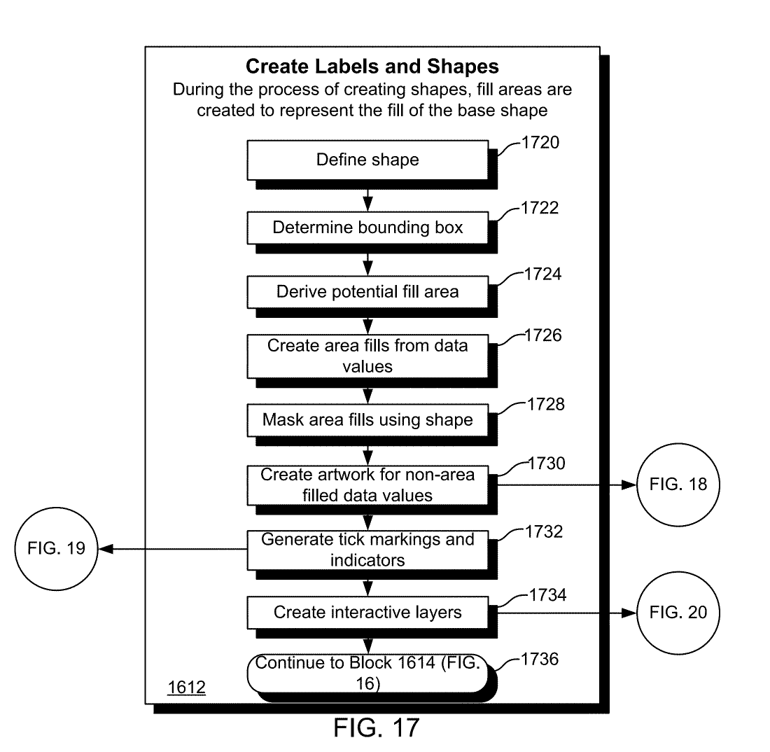

Block 1612 can be broken into additional substeps as seen in FIG. 17. The substeps can carry out operations to create the shape to be filled, create a fill (or fills), and perform graphics functionality to fill one or more portions of the shape with the fill(s) so as to stay within the bounds of the shape. The substeps can also deal with creation of non-area filled artwork, labels, tick markings, indicators, and interactive layers.

Block 1612 can include a substep of defining the shape (Block 1720). The shape can be based on data or an image provided by a user or accessed from a memory. For instance, a user may provide a photograph of the New York skyline. Block 1720 can take this image and convert it to a mere outline of the New York skyline via various graphics algorithms, and this outline can be the shape (e.g., FIG. 2).

A bounding box can then be determined (Block 1722). One method includes determining a maximum pixel height and width of the shape for a given set of perpendicular axes. If the axes are rotated, then different bounding boxes may be determined.

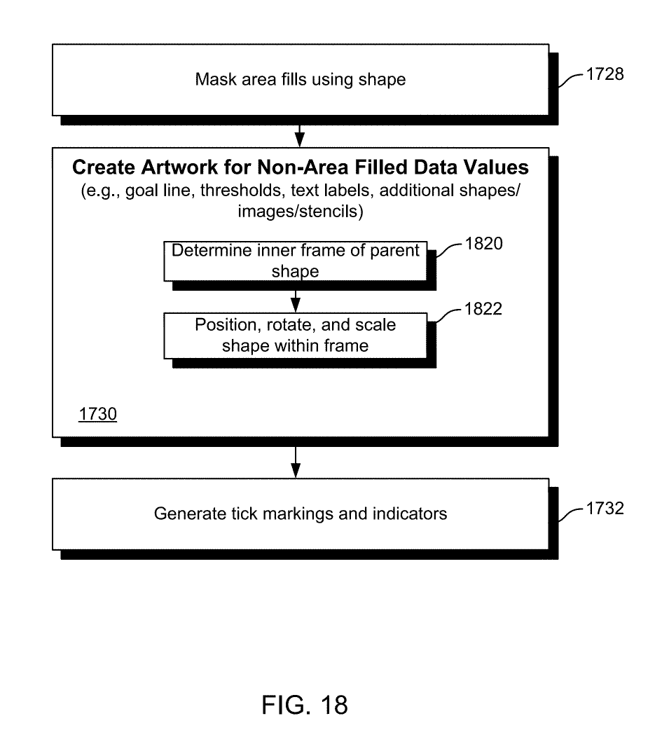

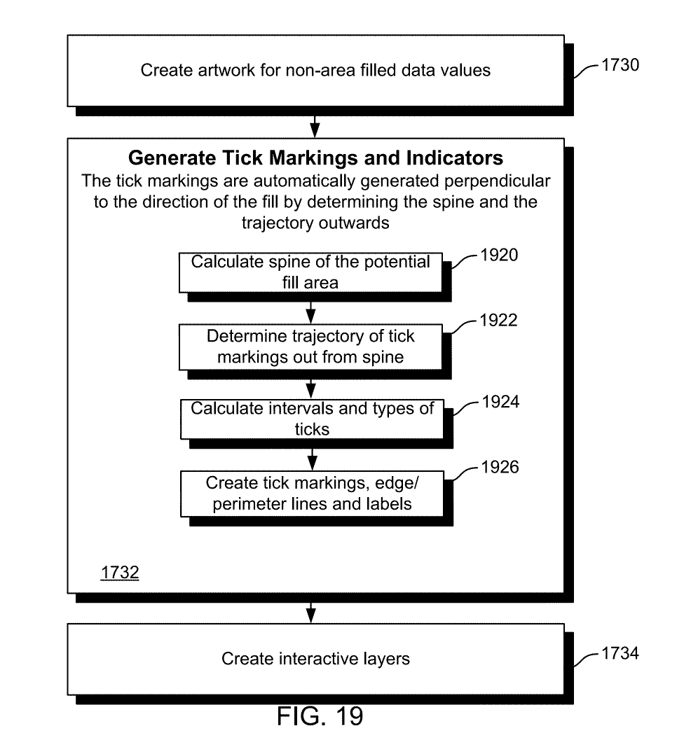

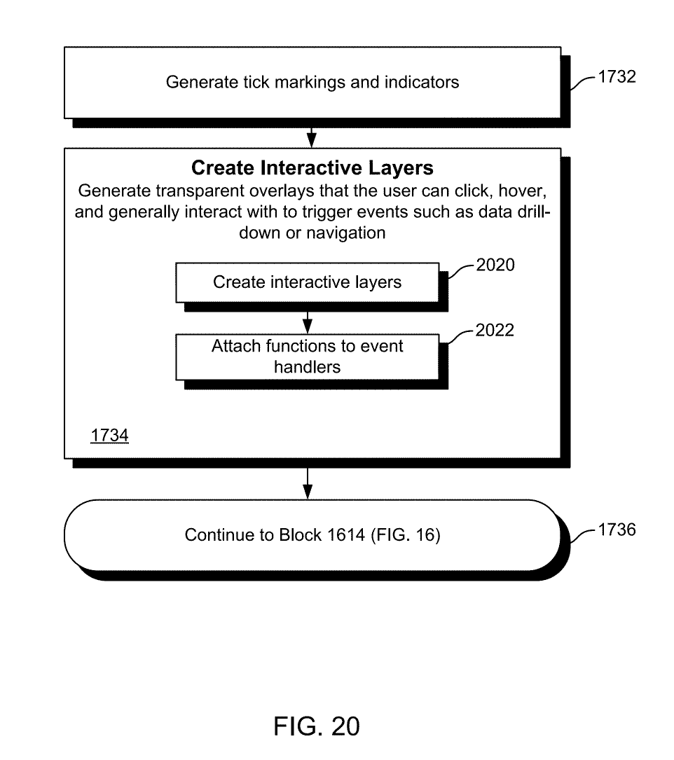

A potential fill area can then be determined (Block 1724) as the area within the bounding box. Based on the data, some portion of the potential fill areas can be filled (Block 1726). These produce a bounding box that is partially filled with a color or texture up to a fill. To convert this rectangular fill into a fill for the shape, a mask is created based on the shape and the mask is used to determine what pixels in the fill area are to be displayed and which ones are to be ignored during rendering (or made transparent or removed from those pixels being displayed) (Block 1728). If non-area filled data values exist, then artwork can be created for these data values (Block 1730 and substeps described in FIG. 18). Tick markings and indicators can be generated (Block 1732 and substeps described in FIG. 19) and interactive layers can be created (Block 1734 and substeps described in FIG. 20).

If non-area filled data values exist (e.g., a goal line, thresholds, milestones), then FIG. 18 shows substeps for creating artwork for these values (e.g., fill colors for different milestones, images to be displayed within or overlapping the shape, text labels, etc.) can be created for these values by first determining an inner frame of a parent shape (Block 1820). Position, rotation, and scale of the artwork can then be determined (Block 1822), and this can again be automated or based on the settings from Block 1602. Once this artwork is created, the metrics engine 1600 can return to Block 1732.

If tick markings and indicators are to be generated, then FIG. 19 shows substeps for creating these tick markings and indicators. These operations begin by calculating a spine of the potential fill area (Block 1920). The spine can be parallel to a vertical dimension of the bounding box, or for fills that follow a changing vector (e.g., FIGS. 13 and 14) the spine can be coextensive with the vector. Alternatively, the spine can be an average of the vector such that tick marks are created relative to a single axis, even though the vector may be changing as the fills expands and contracts. The tick markings can be oriented perpendicular to this spine (Block 1922). Intervals for the tick markings can be determined (Block 1924), optionally as a function of the scale determined in Block 1606. The types of tick markings can also be determined in this sub step and this can either be accessed from a setting stored in memory or a setting provided by a user. The tick markings can then be created (rendered) and written to a buffer in preparation for display (Block 1926). This substep can also include creating edge and perimeter lines as well as labels. Once tick markings and indicators have been created, the metrics engine 1600 can return to Block 1734.

If interactive layers are to be generated, then FIG. 20 shows substeps for creating such interactive layers. Interactive layers can include transparent overlays that the user can click, hover over, and generally interact with in order to trigger events such as data drill downs or other data expansion mechanisms and navigation. Interactive layers can be generated (Block 2020) and then functions to event handlers can be attached to the interactive layers (Block 2022). Given these substeps, the metrics engine 1600 can return to Block 1736.

Once the substeps of FIG. 17 are complete, the metrics engine 1600 continues to Block 1614. Upon completion of all steps in the metrics engine 1600, operations can end or return to a beginning of the metrics engine 1600 or loop back to operations within the metrics engine 1600.

While various operations and substeps have been described and illustrated in a given order, one of skill in the art will recognize that many of these operations and substeps can be performed in parallel, in overlapping fashions, or in different orders. For instance, the tick markings and indicators can be generated in parallel to or before the creation of artwork for non-area filled data values.

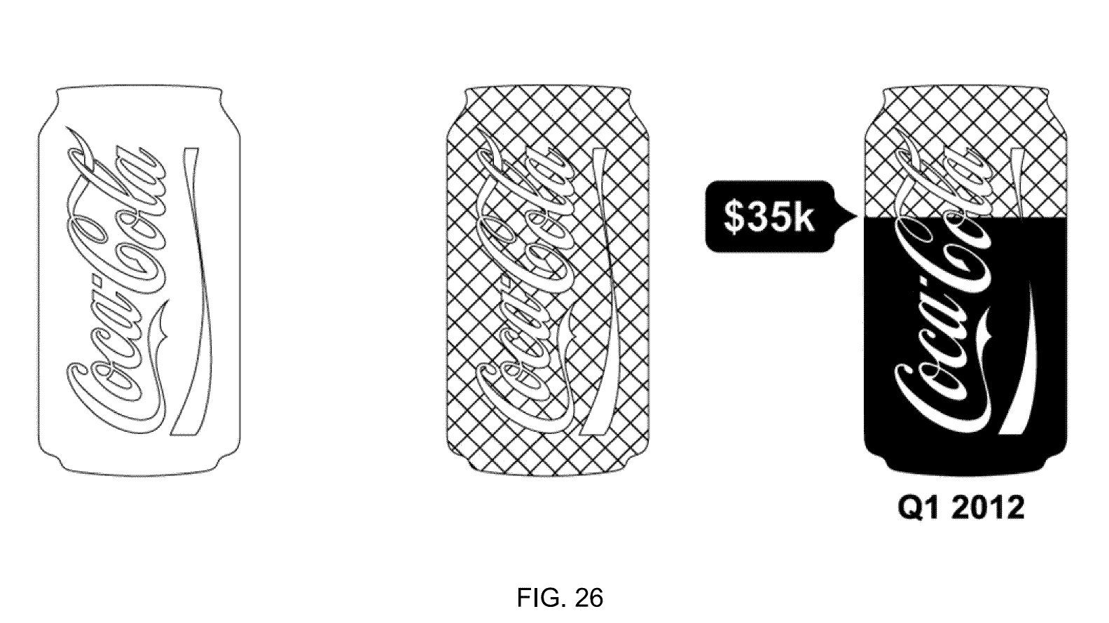

FIG. 22 illustrates a visualization of data using a complex shape. The complex shape is such that existing scripts do not exist for filling this complex shape. For instance, the complex shape could be a company logo. The complex shape can be provided by a user, for instance a draftsperson or photographer. Alternatively, a user can upload an image or select an image from the Internet. The image that includes the complex shape can also be provided on a storage device, such as a memory stick. Various other ways of providing the complex shape are envisioned. In some cases, the complex shape can be simplified, for instance, by extracting an outline or a line drawing of the complex shape (e.g., extracting a line drawing such as an outline from a photograph). The complex shape can be derived or accessed from a user-provided file, such as a digital image file. A line drawing can include an outline plus one or more interior lines that provide some detail of the original image (e.g., see FIG. 26 showing different fills for a line drawing of a soda can). In some cases a line drawing may not include an outline, but merely a simplified line-style rendering of an original image. A line drawing can be devoid of gradations in shade and can be monochromatic, or comprise a single color. Given this shape in a memory, a system can retrieve the complex shape and convert it to a first vector image 2204. The first vector image can include a scalable vector graphic or SVG.

Data can also be retrieved from a memory and a fill level can be calculated based on the data. A scale for the data can be determined, and the fill level can be determined as a percentage of a maximum value in the scale, or alternatively as a percentage of an arbitrary value, or as a percentage of a value that makes the percentage meaningful. The percentage can then be used relative to a dimension of the first vector image to determine a dimension of the fill level. For instance, a maximum value used to determine the percentage may be based on values from other sets of data, such as when two sets of data, or two data points are being compared. The first fill level can correspond to a first dimension of the first vector image, for instance, a height or elevation of the first vector image.

Given the first vector image and the first fill level, a union of the two can be generated and can be referred to as a fill 2208. A second vector image 2210 can be generated that comprises the first fill level 2206 (e.g., a rectangle) bounded by the first vector image 2204. In this way the first fill level 2206 appears to partially or fully fill the first vector image 2204 (here illustrated as partially filling the first vector image 2204). In other words, the second vector image 2204 is generated from the first vector image 2204 and the first fill level 2206. In some embodiments, the fill level 2206 can be rectangular and have at least one dimension that is equal to or greater than a dimension of the first vector image. In the illustrated embodiment, a width of the fill level 2206 is equal to a width of the first vector image 2204, but in other embodiments, this width could be greater than a width of the first vector image 2204. Were the fill level 2206 rotated, then a width of the rotated fill level 2206 would be equal to or greater than a width of the first vector image 2204 measured along a dimension parallel to the width of the rotated fill level 2206.

Subsequently, another data point in the set or a newly-acquired data point can be used to calculate a second fill level (not illustrated) and the union of this second fill level and the first vector image can be determined in order to update the second vector image (i.e., the second vector image 2204 does not need to be redrawn, but rather merely the fill level updated). This process can continue in order to animate the infographic or in order to visualize new data as it becomes available. These techniques can also be used to compare data where similar or different first vector images are displayed next to each other and a union is determined with fill levels based on separate data points.

Prior art scripts do not exist for every shape under the sun, and thus cannot be relied upon to create such infographics for any shape. This disclosure allows a dynamic infographic to be formed from any shape. Further, while an artist can create an infographic for shapes that are not scripted, such infographics cannot be updated or populated with changing or new data since the artist would have to recreate the infographic every time the data changed. The instant systems and methods overcome this challenge by enabling the second vector image 2210, or infographic, for any shape to be generated on the fly, and thereby to update its fill 2208 for any set of data including new data or data that did not exist when the first vector image 2204 was initially generated. In other words, the second vector image 2210 is not selected from a set of previously-generated images, each showing one of a finite number of different fills for a given shape.

Some common scripting methods in the art rely on the “FILL” command in order to fill shapes with color or texture. The instant systems and methods do not call on this command during the generation of the second vector image.

In an embodiment the first vector image 2204 can be assigned transparent pixels such that when the second vector image 2210 is viewed only that portion of the first fill level 2206 that overlaps (or is a union with) with the first vector image 2204 is visible (see the second vector image 2210 in FIG. 22B). Rather than transparent pixels, alpha channels, clipping paths, and/or masking can also be used. For instance, the second vector image 2210 can be formed by using the first vector image 2204 as a mask relative to the fill level 2206, such that only the fill 2208 portion of the fill level 2206 is visible.

A height (or any other dimension) of the fill level 2206 can be computed as a first percentage of the height (or any other dimension) of the first vector image 2204, where this first percentage can correlate to one or more data points in a data set. A height (or other dimension) of a second fill level can be computed as a second percentage of the height (or any other dimension) of the first vector image 2204, where this second percentage can correlate to a second one or more data points in the data set. It should be noted that the area of the fill 2208 is not correlated to either of the one or more data points. Instead a dimension of the fill level 2206 is used. While this is technically less accurate, the visual effect on the viewer is more effective. This is especially true when two second vector images are compared side by side.

In the illustrated embodiment, a height of the first fill level 2206 and a height of the first vector image 2204 are used, however other dimensions can also be used. Typically the desire is that dimensions of the first fill level 2206 and the first vector image 2204 are the same or are parallel. The illustrated fill level 2206 is shown as a cross hatch, although solid colors and repeated shapes as well as other fill styles can also be used.

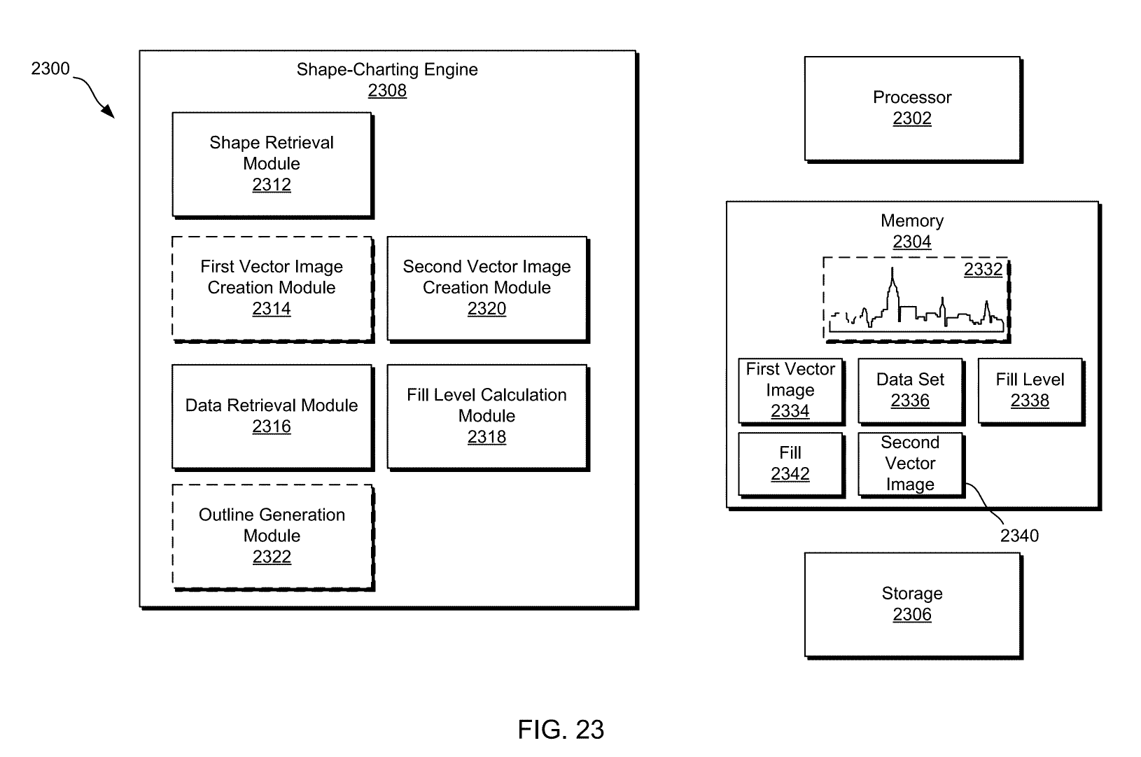

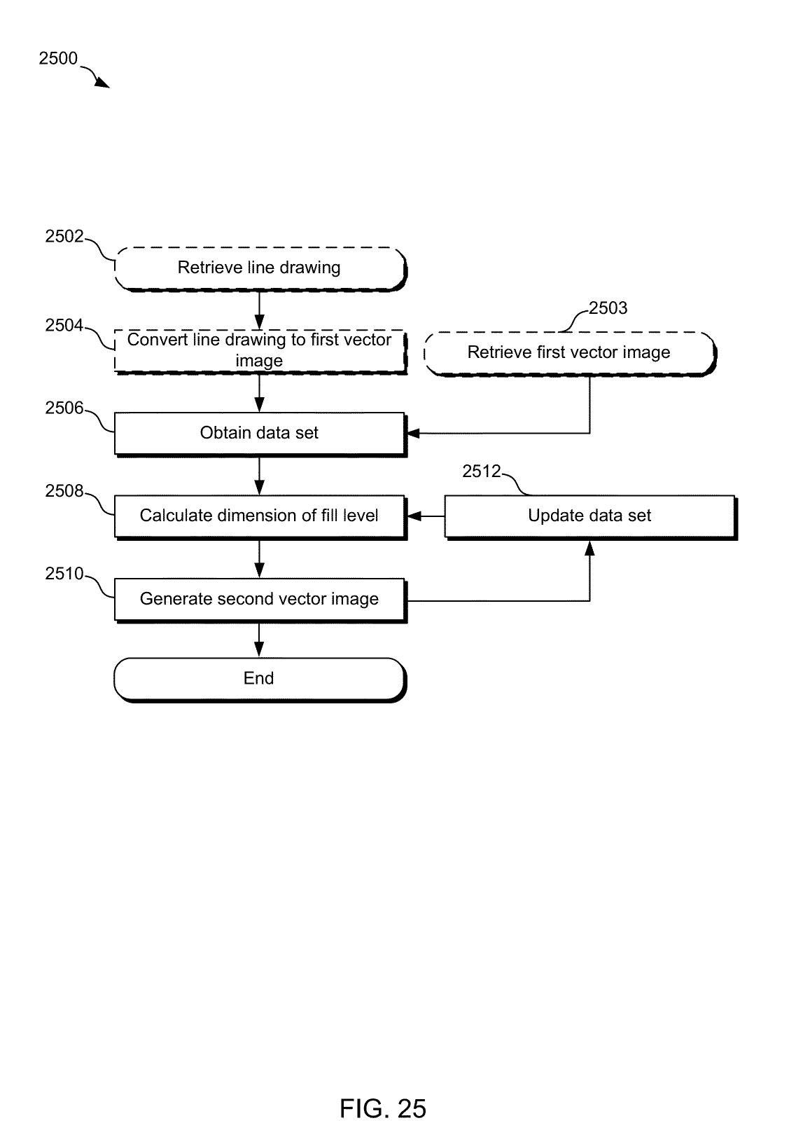

FIG. 23 illustrates a system for visualizing data. The system 2300 can include a processor 2302, a memory 2304, and a storage 2306. Other components common to a computing system are not illustrated for the purposes of simplifying FIG. 23, but one of skill in the art will be well aware of their existence and interaction with the components shown and described herein. The system 2300 can also include a shape-charting engine that is stored on the storage 2306 in the form of one or more non-transitory, tangible computer readable storage meda, encoded with processor readable instructions for performing the functions and methods elsewhere described in this disclosure (e.g., functionality carried out by the modules described below relative to FIG. 23 or the functional blocks of FIG. 25). The shape-charting engine can also temporarily reside on, store data on, and retrieve data from the memory 2304. The instructions can be processed on and carried out by the processor 2302.

The shape-charting engine 2308 can include a shape retrieval module 2312 configured to retrieve a shape 2332, possibly from the memory 2304 or the storage 2306. The shape 2332 can be derived from a user-provided image and can include drawings, photographs, logos, symbols, icons. In some instances, the shape 2332 can be a simplified version of the user-provided image and can include an outline or line drawing. The shape 2332 can be a raster image. The shape-charting engine 2308 can also include a first vector image creation module 2314 configured to convert the shape 2332 to a first vector image 2334 (e.g., first vector image 2204), if needed. Alternatively, the shape-charting engine 2308 may start with the first vector image 2334 and thus not use or need a first vector image creation module 2314 (which is optional). In this case, the shape retrieval module 2312 can merely retrieve the first vector image 2334.

The shape-charting engine 2308 can also include a data retrieval module 2316 configured to obtain a data set 2336. The data set 2336 is illustrated as residing on the memory 2304, but can also be stored on the storage 2306. The data set 2336 can include data that is to be displayed in a visually-useful form such as via one or more infographics.

The shape-charting engine 2308 can also include a fill level calculation module 2318. The fill level calculation module 2318 can be configured to calculate a first dimension of a fill level 2338 (e.g., a height, such as the height of the fill 206 in FIG. 2 or the height of the fill level 2206 in FIG. 22). The first dimension can be calculated as a percentage of a second dimension of the first vector image 2334, where the percentage corresponds to one or more data points in the data set 2336. For instance, the first dimension can be related to the second dimension as a first data point in the data set 2336 is related to a maximum data point in the data set 2336.

The shape-charting engine 2308 can also include a second vector image creation module 2320. The second vector image creation module 2320 can be configured to generate a second vector image 2340 comprising the fill level 2338 bounded by the first vector image 2334 so that the fill level 2338 appears to partially or fully fill the first vector image 2334 when the second vector image 2340 is created. Further, the second vector 2340 image can be generated from the first vector image 2334 and the fill level 2338. In another embodiment, the second vector image creation module 2320 can be configured to generate the second vector image 2340 from the first vector image 2334 and a union of the fill level 2338 and the first vector image 2334. The shape-charting engine 2308 can also utilize a mask to generate the second vector image 2334.

In an embodiment, the fill level calculation module 2318 dynamically calculates different fill levels 2338 based on different data points in the data set 2336, where the different data points can be added to the data set 2336 at different times or at the same time. For instance, the fill level calculation module 2318 may calculate a new fill level 2338 based on a data point added to the data set 2336 after the second vector image 2340 is created, such that an updated second vector image 2340 can be generated. Similarly, when a new fill level 2338 is generated, the second vector image creation module 2320 can update the second vector image 2340 or create a new second vector image 2340 based on a union between the new fill level 2338 and the first vector image 2334.

The shape-charting engine 2308 can also optionally include an outline generation module 2322 configured to generate the shape 2332 from more complex images such as photographs, drawings, and other images having more information than is needed for the first vector image 2334.

In some embodiments, a new shape 2332 can be retrieved by the shape retrieval module 2312, the first vector image creation module 2314 can generate a new first vector image 2334, the fill level calculation module 2318 can generate a new fill level 2338 (or the same fill level 2338 can be used if the data to be illustrated within the new shape 2332 has not changed), and the second vector image creation module 2320 can generate a new second vector image 2340. Alternatively, a new first vector image 2334 can be obtained by the shape retrieval module 2312, the fill level calculation module 2318 can generate a new fill level 2338 (or the same fill level 2338 can be used if the data to be illustrated within the new shape 2332 has not changed), and the second vector image creation module 2320 can generate a new second vector image 2340.

In the prior art, where an existing script for the first vector image 2334 does not exist, the second vector image 2340 could only be created via an artist creating individual images for each fill 2342. Thus, the ability to create on the fly fillable graphics for any shape (e.g., company logos and outlines derived from photographs) was not possible.

FIG. 25 illustrates a method of visualizing data according to one embodiment of this disclosure. The method 2500 can include retrieving a line drawing (Block 2502). The method 2500 can then convert the line drawing to a first vector image (Block 2504), such as the first vector image 2334 in FIG. 23. In an alternative embodiment, rather than start with a line drawing, the method 2500 can start by retrieving a first vector image (Block 2503). Whether the vector image is generated from a line drawing (Blocks 2502 and 2504) or retrieved as a first vector image (Block 2503), the method 2500 proceeds along a common path from this point. The method 2500 can further obtain a data set (Block 2506) such as the data set 2336 in FIG. 23. The method 2500 can calculate a dimension of the fill level (Block 2508) based on the data set. The fill level can be rectangular and can have at least one dimension that is equal to or greater than a dimension of the first vector image. The method 2500 can then generate a second vector image (Block 2510 such as the second vector image 2340 in FIG. 23. The second vector image can comprise the fill level bounded by the first vector image so that the fill level appears to partially or fully fill the first vector image. The second vector image can be generated from the first vector image and the fill level. The method 2500 can then end or can loop back for a new or additional data point(s). In particular, the method 2500 can then update the data set (Block 2512) and then repeat the calculation of the dimension of the fill level (Bock 2508) based on the updated data set, and then update the second vector image (Block 2510) with the updated fill level. This process can repeat for any updates to the data set such that various update to the second vector image can be performed after an initial data set is known and after the first vector image is created or obtained.

FIG. 26 shows three different aspects of an infographic according to embodiments of this disclosure. The right-hand figure shows a line drawing of a shape. The middle figure shows via cross hatching those portions of the line drawing that can potentially be filled. The right-hand figure shows a second vector image, where a black fill is applied above a half-way point on the can. Additionally, a “$35 k” marker is added to provide a numerical value to go with the visualization of the data.

In FIG. 26, the cross hatching can be embodied by a grey color. This grey color helps distinguish the potentially-filled area from area surrounding the can. The grey area can show the user that the fill is a percentage of some value.

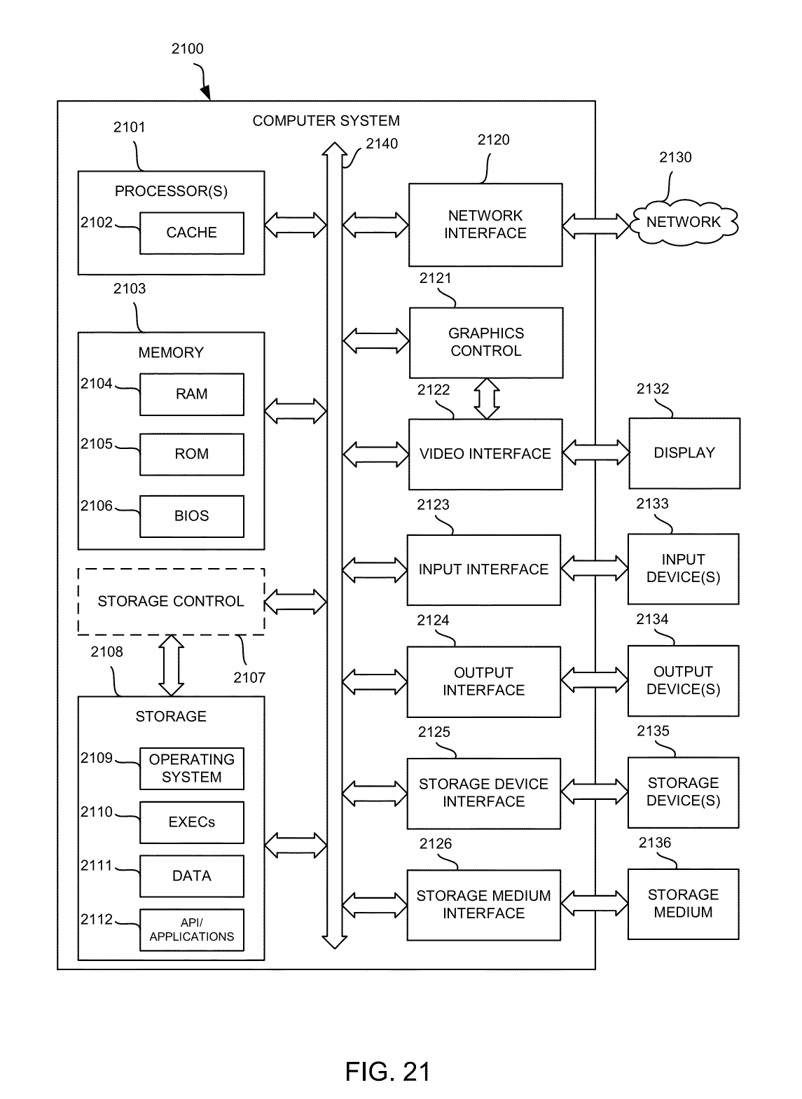

The systems and methods described herein can be implemented in a computer system in addition to the specific physical devices described herein. FIG. 21 shows a diagrammatic representation of one embodiment of a computer system 2100 within which a set of instructions can execute for causing a device to perform or execute any one or more of the aspects and/or methodologies of the present disclosure. A laptop, smartphone, or tablet computer are just three non-limiting examples of the computer system 2100. The components in FIG. 21 are examples only and do not limit the scope of use or functionality of any hardware, software, firmware, embedded logic component, or a combination of two or more such components implementing particular embodiments of this disclosure. Some or all of the illustrated components can be part of the computer system 2100. For instance, the computer system 2100 can be a general purpose computer (e.g., a laptop computer) or an embedded logic device (e.g., an FPGA), to name just two non-limiting examples.

Computer system 2100 includes at least a processor 2101 such as a central processing unit (CPU) or an FPGA to name two non-limiting examples. Processor 2302 in FIG. 23 is one implementation of the processor 2101. The computer system 2100 may also comprise a memory 2103 and a storage 2108, both communicating with each other, and with other components, via a bus 2140. Memory 2304 in FIG. 23 is one implementation of the memory 2103. The bus 2140 may also link a display 2132, one or more input devices 2133 (which may, for example, include a keypad, a keyboard, a mouse, a stylus, etc.), one or more output devices 2134, one or more storage devices 2135, and various non-transitory, tangible computer-readable storage media 2136 with each other and with one or more of the processor 2101, the memory 2103, and the storage 2108. All of these elements may interface directly or via one or more interfaces or adaptors to the bus 2140. For instance, the various non-transitory, tangible computer-readable storage media 2136 can interface with the bus 2140 via storage medium interface 2126. Computer system 2100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 2101 (or central processing unit(s) (CPU(s))) optionally contains a cache memory unit 2102 for temporary local storage of instructions, data, or computer addresses. Processor(s) 2101 are configured to assist in execution of computer-readable instructions stored on at least one non-transitory, tangible computer-readable storage medium. Computer system 2100 may provide functionality as a result of the processor(s) 2101 executing software embodied in one or more non-transitory, tangible computer-readable storage media, such as memory 2103, storage 2108, storage devices 2135, and/or storage medium 2136 (e.g., read only memory (ROM)). For instance, the method employed by the metrics engine 1600 in FIG. 16 and the shape-charting engine 2308 in FIG. 23 may be embodied in one or more non-transitory, tangible computer-readable storage media. The non-transitory, tangible computer-readable storage media may store software that implements particular embodiments, such as the methods described in FIGS. 16-20 and 25, and processor(s) 2101 may execute the software. Memory 2103 may read the software from one or more other non-transitory, tangible computer-readable storage media (such as mass storage device(s) 2135, 2136) or from one or more other sources through a suitable interface, such as network interface 2120. The WIFI modem of a smartphone is one embodiment of the network interface 2120. The software may cause processor(s) 2101 to carry out one or more processes or one or more steps of one or more processes described or illustrated herein. Carrying out such processes or steps may include defining data structures stored in memory 2103 and modifying the data structures as directed by the software. In some embodiments, an FPGA can store instructions for carrying out functionality as described in this disclosure (e.g., the methods of FIGS. 16-20 and 25). In other embodiments, firmware includes instructions for carrying out functionality as described in this disclosure (e.g., the methods carried out in FIGS. 16-20 and 25).

The memory 2103 may include various components (e.g., non-transitory, tangible computer-readable storage media) including, but not limited to, a random access memory component (e.g., RAM 2104) (e.g., a static RAM “SRAM”, a dynamic RAM “DRAM, etc.), a read-only component (e.g., ROM 2105), and any combinations thereof. ROM 2105 may act to communicate data and instructions unidirectionally to processor(s) 2101, and RAM 2104 may act to communicate data and instructions bidirectionally with processor(s) 2101. ROM 2105 and RAM 2104 may include any suitable non-transitory, tangible computer-readable storage media described below. In some instances, ROM 2105 and RAM 2104 include non-transitory, tangible computer-readable storage media for carrying out the methods carried out in FIGS. 16-20 and 25. In one example, a basic input/output system 2106 (BIOS), including basic routines that help to transfer information between elements within computer system 2100, such as during start-up, may be stored in the memory 2103.

Fixed storage 2108 is connected bidirectionally to processor(s) 2101, optionally through storage control unit 2107. Fixed storage 2108 provides additional data storage capacity and may also include any suitable non-transitory, tangible computer-readable media described herein. Storage 2108 may be used to store operating system 2109, EXECs 2110 (executables), data 2111, API applications 2112 (application programs), and the like. For instance, the storage 2108 could be implemented for storage of settings as described in FIG. 16 and computer readable media for the shape-charting engine 2308 in FIG. 23. Often, although not always, storage 2108 is a secondary storage medium (such as a hard disk) that is slower than primary storage (e.g., memory 2103). Storage 2108 can also include an optical disk drive, a solid-state memory device (e.g., flash-based systems), or a combination of any of the above. Information in storage 2108 may, in appropriate cases, be incorporated as virtual memory in memory 2103.

In one example, storage device(s) 2135 may be removably interfaced with computer system 2100 (e.g., via an external port connector (not shown)) via a storage device interface 2125. Particularly, storage device(s) 2135 and an associated machine-readable medium may provide nonvolatile and/or volatile storage of machine-readable instructions, data structures, program modules, and/or other data for the computer system 2100. In one example, software may reside, completely or partially, within a machine-readable medium on storage device(s) 2135. In another example, software may reside, completely or partially, within processor(s) 2101.

Bus 2140 connects a wide variety of subsystems. Herein, reference to a bus may encompass one or more digital signal lines serving a common function, where appropriate. Bus 2140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 2100 may also include an input device 2133. In one example, a user of computer system 2100 may enter commands and/or other information into computer system 2100 via input device(s) 2133. Examples of an input device(s) 2133 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 2133 may be interfaced to bus 2140 via any of a variety of input interfaces 2123 (e.g., input interface 2123) including, but not limited to, serial, parallel, game port, USB, FIREWIRE, THUNDERBOLT, or any combination of the above.

In particular embodiments, when computer system 2100 is connected to network 2130 (such as a corporate LAN network), computer system 2100 may communicate with other devices, such as mobile devices and enterprise systems, connected to network 2130. Communications to and from computer system 2100 may be sent through network interface 2120. For example, network interface 2120 may receive incoming communications (such as requests or responses from other devices) in the form of one or more packets (such as Internet Protocol (IP) packets) from network 2130, and computer system 2100 may store the incoming communications in memory 2103 for processing. Computer system 2100 may similarly store outgoing communications (such as requests or responses to other devices) in the form of one or more packets in memory 2103 and communicated to network 2130 from network interface 2120. Processor(s) 2101 may access these communication packets stored in memory 2103 for processing.

Examples of the network interface 2120 include, but are not limited to, a network interface card, a modem, and any combination thereof. Examples of a network 2130 or network segment 2130 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 2130, may employ a wired and/or a wireless mode of communication. In general, any network topology may be used.

Information and data can be displayed through a display 2132. Examples of a display 2132 include, but are not limited to, a liquid crystal display (LCD), an organic liquid crystal display (OLED), a cathode ray tube (CRT), a plasma display, and any combinations thereof. The display 2132 can interface to the processor(s) 2101, memory 2103, and fixed storage 2108, as well as other devices, such as input device(s) 2133, via the bus 2140. The display 2132 is linked to the bus 2140 via a video interface 2122, and transport of data between the display 2132 and the bus 2140 can be controlled via the graphics control 2121.

In addition to a display 2132, computer system 2100 may include one or more other peripheral output devices 2134 including, but not limited to, an audio speaker, a printer, and any combinations thereof. Such peripheral output devices may be connected to the bus 2140 via an output interface 2124. Examples of an output interface 2124 include, but are not limited to, a serial port, a parallel connection, a USB port, a FIREWIRE port, a THUNDERBOLT port, and any combinations thereof.

In addition or as an alternative, computer system 2100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., the methods carried out in FIGS. 16-20 and 25) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for visualizing data, the system comprising:
a memory that stores a data set;
a shape-charting engine comprising:
a shape retrieval module configured to retrieve a shape;
a first vector image creation module configured to convert the shape to a first vector image;
a data retrieval module configured to obtain a data set;
a fill level calculation module configured to calculate a height of a fill level as a percentage of a height of the first vector image, where the percentage corresponds to one or more data points in the data set; and
a second vector image creation module configured to generate a second vector image comprising the fill level bounded by the first vector image so that the fill level appears to partially or fully fill the first vector image when the second vector image is created, wherein the second vector image is generated from the first vector image and the fill level.

2. The system of claim 1, wherein the fill level is a rectangle and only a portion of this rectangle is visible in the second vector image.

3. The system of claim 1, wherein the fill level fills less than all of the first vector image.

4. The system of claim 1, wherein the fill level dynamically adjusts within the shape for different values within the data set.

5. The system of claim 3, wherein the second vector image is updated on the fly rather than being selected from a plurality of previously-generated images each showing one of a finite number of different fills for the shape.

6. The system of claim 1, wherein the second vector image is a scalable vector graphic.

7. The system of claim 1, wherein a height of the fill level changes for different data values.

8. The system of claim 7, wherein an area of the fill relative to an area of the first vector image is unrelated to the data set.

9. A system for visualizing data, the system comprising:
a shape retrieval module configured to retrieve a first vector image;
a data retrieval module configured to obtain a data set;
a fill level calculation module configured to calculate a plurality of fill levels as percentages of a first dimension of the first vector image, where each of the percentages corresponds to a data point in the data set; and
a second vector image creation module configured to generate a second vector image with a changing fill, the fill based on a union between one of the fill levels and the first vector image.

10. The system of claim 9, wherein the fill levels each have a second dimension parallel to the first dimension of the first vector image, and wherein the percentages equal the second dimension divided by the first dimension.

11. The system of claim 10, wherein the second vector image changes for each of the plurality of fill levels.

12. The system of claim 11, wherein the second vector image is updated on the fly rather than being selected from a plurality of previously-generated images each showing one of a finite number of different fills for the first vector image.

13. The system of claim 9, wherein the fill levels are rectangles and only a portion of the rectangles that is within the first vector image are visible in the second vector image.

14. The system of claim 9, wherein at least one of the fill levels fills less than all of the first vector image.

15. The system of claim 9, wherein the second vector image is a scalable vector graphic.

16. The system of claim 9, wherein an area of the union between the fill levels and the first vector image relative to an area of the first vector image is unrelated to a data set used to determine the second dimension.

17. A non-transitory, tangible computer readable storage medium, encoded with processor readable instructions to perform a method for visualizing data, the method comprising:
retrieving a first vector image;
obtaining a data set;
calculating a dimension of a first fill level based on the data set, the first fill level being rectangular and having at least one dimension that is equal to or greater than a dimension of the first vector image; and
generating a second vector image comprising the first fill level bounded by the first vector image so that the first fill level appears to partially or fully fill the first vector image, wherein the second vector image is generated from the first vector image and the fill level,
where the second vector image is generated on the fly rather than being selected from a plurality of previously-generated images each showing one of a finite number of different fill levels for the first vector image.

18. The non-transitory, tangible computer readable storage medium of claim 17, wherein the second vector image is updated using data accessed after initial generation of the second vector image.
